(19) United States
(12) Patent Application Publication
(10) Pub. No.: US 2002/0087440 A1
(43) Pub. Date: Jul. 4, 2002

(54) Method for reconstructing and validating a bill of materials and creating a comprehensive bill of materials

(76) Inventors: William R. Blair, Erie, PA (US); John E. Allamon, Erie, PA (US)

Correspondence Address: Daniel H. Golub, MORGAN, LEWIS & BOCKIUS LLP, 1701 Market Street, Philadelphia, PA, 19103-2921, US

(21) Appl. No.: 09/836,739

(22) Filed: Dec. 29, 2000

(51) Int. Cl. G06F 17/60

(52) U.S. Cl. 705/29

(57) ABSTRACT

A method and system for validating bill of materials information is disclosed, which includes use of a template which defines a bill of materials information structure. The bill of materials information is received in flat file format and comprises, including part data information. The flat file is compared to the bill of materials information structure and the part data information is analyzed for inconsistencies. A report is generated which includes error information representing the differences between the flat file and the bill of materials information structure and part data information inconsistencies. A method and system of reconstructing a bill of materials for one assembly as well as of reconstructing a comprehensive bill of materials for multiple assemblies is also disclosed.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The disclosed invention relates generally to validating and reconstructing, automatically, a bill of materials for a product assembly. The disclosed invention also relates to aggregating bill of materials information for multiple product assemblies.

2. Description of the Background

A Request for Quotation (“RFQ”) is a set of documentation that communicates a buying organization's intent to buy goods and/or services. By issuing an RFQ, the buying organization is requesting multiple potential suppliers to submit quoted prices for the items identified in the RFQ. An RFQ typically contains all of the information needed for a supplier to determine whether to quote, and at what price.

In, for example, the context of a supplier-bidding auction, the RFQ refers to the information provided to prospective suppliers prior to the auctioning event that describes all of the individual items up for bid, and other specifications that would affect cost to the bidder. The RFQ typically includes technical, commercial, logistical and quality specifications. RFQs used in online auctions between a buyer and a plurality of potential suppliers may also have information about the upcoming online auction, such as auction start and stop times, bidding requirements and rules for participating in the auction. In addition, if the auction has the commodities separated into lots, the RFQ may contain information about the lots, and details about each line item in the lot. By reviewing the RFQ, potential suppliers can determine whether they wish to participate in an upcoming online auction, which lots they wish to bid on and plan a strategy for competitive bidding.

In online auctions, suppliers rely heavily on the information in the RFQ when making bids in the auction. It is therefore important that the information in an RFQ be as detailed and accurate as possible. If the RFQ were not sufficiently detailed, a supplier may not bid as low as he otherwise would, as a way of hedging against the potential unforeseen costs that are not explicitly identified in the RFQ. In a buyer-sponsored auction, where the buyer is seeking to save money by obtaining the lowest possible price by using auctioning technology, inaccurate or insufficiently detailed RFQs result in less cost savings for the buyer. Thus, there is a need to create RFQs that are as accurate as possible, without sacrificing the time required to create the RFQ.

RFQs contain a wide variety of information that may come from many different sources. The information that is acquired from these sources may include paper documents and electronic files. The electronic files may be of any number of known file types, such as Computer-Aided Design (“CAD”) files, Microsoft Word documents, basic text files, PowerPoint slides, and Excel spreadsheets, just to name a few.

One item of information contained in an RFQ is a Bill of Materials (“BOM”). A BOM is a list of all the materials necessary to manufacture a particular assembly and contains detailed information about such materials. The concept of the BOM has been used for some time in various industries. However, the prior art BOMs were constructed manually. Given that a BOM for a given assembly may include detailed information for thousands of parts, manual construction can be time intensive and prone to errors. Thus, there exists a need for a method and system for validating the information contained in the BOM and automatically constructing a BOM including the validated information.

Many organizations store BOM information for their product assemblies in Enterprise Resource Planning (“ERP”) systems or Management Planning Resource (“MPR”) systems, such as those offered by SAP, Oracle or J. D. Edwards. Thus, different organizations may store their BOM information in different types of files, creating lack of uniformity among organizations. In addition, through acquisitions, mergers or similar transactions, an organization may acquire other business units that utilize different ERP/MRP systems and that maintain their BOM information for their product assemblies in different types of files, thereby creating lack of uniformity within an organization. Standardizing the BOM file format would facilitate validating the information contained in the BOM, reconstructing the BOM and including the BOM information in an RFQ. Thus, there exists a need for a method which standardizes the BOM file format.

Several business units within an organization may utilize the same parts or subparts in their various product assemblies. Economies of scale in procurement of these parts and subparts may be achieved by such an organization if it is able to aggregate the parts and subparts required for some or all of its business units' product assemblies for inclusion in an RFQ. Thus, there exists a need for a system and method of constructing a comprehensive BOM, which aggregates the parts and subparts utilized by each business unit in its product assemblies.

### SUMMARY OF THE INVENTION

The present invention is directed to a method and system for validating bill of materials information. A template is provided which defines a bill of materials information structure. The bill of materials information is received in flat file format and comprises part data information. The flat file is read. The flat file is compared to the bill of materials information structure and the part data information is analyzed for inconsistencies. One or more reports are generated which include error information representing the differences between the flat file and the bill of materials information structure and part data information inconsistencies.

The present invention is further directed to a method and system of reconstructing a bill of materials for an assembly, wherein the assembly comprises at least one upper level part. The flat file is received and comprises one or more records. At least one of the records comprises information regarding the at least one upper level part and lower level part information associated with the upper level part. The flat file is read and all lower level part information associated with each upper level part is identified. A report comprising a list of all the identified lower level part information for each of the upper level parts is generated.

The present invention is further directed to a system and method of generating a comprehensive bill of materials for a plurality of assemblies, wherein the assemblies comprise at least one upper level part. At least one flat file, each comprising one or more records, is received. At least one of the records comprises information regarding the upper level part and lower level part information associated with the at least one upper level part. Each flat file is read and all lower level part information associated with each of the upper level parts is identified. A report comprising a list of all the identified lower level part information for each of the upper level parts, for all of the assemblies, is generated.

Accordingly, the present invention provides solutions to the shortcomings of prior art BOM-related systems and methods. Those of ordinary skill in the art will readily appreciate, therefore, that those and other details, features, and advantages will become further apparent in the following detailed description of the preferred embodiments.

### BRIEF DESCRIPTION OF THE DRAWINGS

The accompanying drawings, wherein like reference numerals are employed to designate like parts or steps, are included to provide a further understanding of the invention, are incorporated in and constitute a part of this specification, and illustrate embodiments of the invention that together with the description serve to explain the principles of the invention.

In the drawings:

FIG. 1A is a schematic illustration of the entities involved in an embodiment of an auction wherein the sponsor identifies goods or services to be purchased in a request for quotation;

FIG. 1B is a schematic illustration of entities participating in an embodiment of an auction;

FIG. 1C is a schematic illustration of entities participating in an embodiment of a contract award following an auction;

FIG. 2 is a schematic illustration of communications links between the coordinator, the buyer, and the suppliers in an embodiment of an auction;

FIG. 3 is a schematic illustration of auction software and computers hosting that software in an embodiment of an auction;

FIG. 4 is a schematic illustration of an embodiment of an auction network;

FIGS. 5A through 5I provide an example of the standardized template for bill of materials information used in a preferred embodiment of the present invention;

FIGS. 6A through 6K provide an example of an ASCII file used in accordance with a preferred embodiment of the present invention;

FIGS. 7A and 7B provide an example of pages from a web site through which the systems of the present invention can be accessed;

FIG. 8 provides an embodiment of the inventive system network;

FIG. 9 provides an example of a BOM reconstructed by the inventive system;

FIG. 10 provides a flow chart illustrating a method of reconstructing a BOM in accordance with a preferred embodiment of the present invention;

FIG. 11 provides a flow chart illustrating a method of reconstructing a comprehensive BOM in accordance with a preferred embodiment of the present invention;

FIG. 12A through 12D provide an example of excerpts from a collection of comprehensive BOMs generated in accordance with the inventive system;

FIG. 13 provides an example of a cost estimate per assembly spreadsheet generated in accordance with the inventive system;

FIG. 14 provides a flow chart illustrating a method of validating BOM information in accordance with the inventive system; and

FIG. 15 provides an example of an error file generated in accordance with the present invention.

### DETAILED DESCRIPTION

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical auction systems and computer networks. The present invention described below extends the operation of the inventive auction systems and methods described in greater detail in co-pending application Ser. No. 09/252,790, entitled “Method and System for Controlling Closing Times of Electronic Auctions Involving Multiple Lots” filed Feb. 19, 1999, the disclosure of which is hereby expressly incorporated in the present application.

The BOM of the present invention may be used, for example, as part of an RFQ submitted in connection with an auction, as described in more detail below. However, while the auction environment is discussed herein by way of example, it is not the only context in which the BOM-related systems and methods of the present invention may be used. Indeed, the systems and methods of the present invention may be used in any context in which there exists a need for validating the information contained in a BOM and reconstructing a BOM through automated means. In addition, the systems and methods of the present invention may be used in any context in which there exists a need for aggregating bill of materials information, for example, originating from a number of different business units within an organization.

### The Auction

In a supplier-bidding auction or reverse auction, bids, which are often in the form of a price quote, typically start high and move downward over time as bidders interact to establish a closing price. Typically, the auction marketplace is one-sided, with one buyer and many potential suppliers, although multiple-buyer auctions are possible. Typically, products are purchased in the form of components or materials. “Components” may include fabricated tangible pieces or parts that become parts of assemblies of durable products. Example components include gears, bearings, and appliance shelves. “Materials” may include bulk quantities of raw materials that are further transformed into products. Example materials include corn syrup and sheet steel. Services may also be purchased in such a reverse auction.

Industrial buyers do not typically purchase one component at a time. Rather, they tend to purchase whole families of similar components. Therefore, in a typical industrial supplier-bidding auction, products are grouped together in “lots” of related items for bidding. In a regular lot bidding auction, each lot is composed of several “line items.” In the regular lot bidding auction, the suppliers bid on each line item and the bidder 30 having the best bid for all of the parts in the lot is the best bidder 30. The best bidder 30 is typically awarded a contract to supply the items in the lot. In an aggregate type lot bid, a single bid for all of the line items is submitted by each bidder 30 and the bidder 30 submitting the lowest aggregate price is the best bidder 30. By lotting products, potential suppliers can bid on lots for which they are best suited, and are not typically required to bid on every lot. Such a division into lots beneficially reduces the barrier to entry for new potential suppliers that only have capability to supply some of the needed products in the auction. Reducing the barrier to entry also benefits the purchaser by injecting additional bidders 30 into bidding for certain lots.

Typically, components in a lot are related to one another such that it is more efficient to have a supplier provide all of the components in that lot. As an example, a buyer might purchase a given plastic knob in two different colors, or might purchase a nameplate in four different languages. Those parts are so similar that it is nearly always more efficient to purchase those related components from the same supplier because, for example, all of the knobs may be made using with same mold. Thus, such related items are typically grouped in a single “lot.” As is known by one skilled in the art, there are many additional methods of lotting products for an auction.

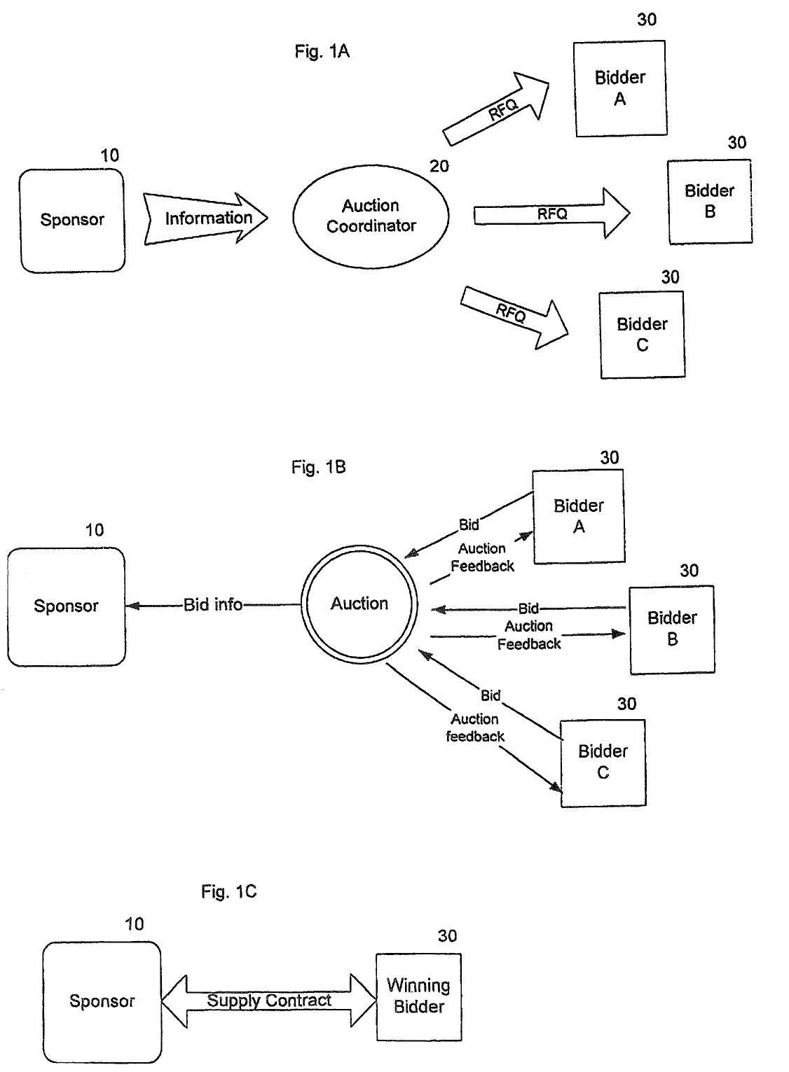

The basic process for a purchaser sponsored supplier-bidding or reverse auction, as conducted by the assignee of the present invention, is described below with reference to FIG. 1. FIG. 1 illustrates the functional elements and entities involved in setting up and conducting a typical supplier-bidding auction. FIG. 1A illustrates the creation of an auctioning event, FIG. 1B illustrates the bidding during an auction, and FIG. 1C illustrates results after completion of a successful auction.

As will be apparent to one skilled in the art, while the invention is generally described in terms of one buyer and multiple suppliers, the present invention may also be used in other types of electronic markets, such as auctions having multiple potential buyers and sellers, forward auctions having a single seller and multiple potential purchasers, upward-bidding auctions, or electronic exchange marketplaces. The term “sponsor” will be utilized herein to identify the party or parties that originate the auction. In a forward auction, for example, the sponsor would typically be the supplier or seller of one or more goods or services. In such a forward auction, that sponsor might state a good that it desires to sell and receive bids from parties wishing to purchase that good. Those parties wishing to purchase that good would furthermore be “bidders” 30 in such a forward auction.

In a reverse auction example, the sponsor would typically be the purchaser or buyer of one or more goods or services. In such a reverse auction, that sponsor might state a good that it desires to purchase and receive bids from parties wishing to supply that good. Those parties wishing to supply that good would furthermore be “bidders” 30 in such a reverse auction.

In the typical supplier-bidding reverse auction model, the product or service to be purchased is usually defined by the sponsor of the auction. As shown in FIG. 1A, when the sponsor 10 decides to use the auctioning system of the present invention to procure products or services, the sponsor 10 provides information to an auction coordinator 20. That information may include information about incumbent suppliers and historic prices paid for the products or services to be auctioned, for example. Typically, the sponsor 10 may also work with the auction coordinator 20 to define the products and services to be purchased in the auction and, if desired, lot the products and services appropriately so that needed products and services can be procured using optimal auction dynamics. A specification may then be prepared for each desired product or service, and an RFQ, with the BOM information included therein, generated for the auction.

Next, the auction coordinator 20 typically identifies potential suppliers 30, preferably with input from the sponsor 10, and invites the potential suppliers 30 to participate in the upcoming auction. The suppliers 30 that are selected to participate in the auction become bidders 30 and may be given access to the RFQ, typically through an RFQ in a tangible form, such as on paper or in an electronic format.

As shown in FIG. 1B, during a typical auction, bids are made for lots. Bidders 30 may submit actual unit prices for all line items within a lot, however, the competition in an auction is typically based on the aggregate value bid for all line items within a lot. The aggregate value bid for a lot may, therefore, depend on the level and mix of line item bids and the quantity of goods or services that are offered for each line item. Thus, bidders 30 submitting bids at the line item level may actually be competing on the lot level. During the auction, the sponsor 10 can typically monitor the bidding as it occurs. Bidders 30 may also be given market feedback during the auction so that they may bid competitively.

Feedback, including bidder 30 identity, about bidding activity is referred to as “market feedback” and includes any information or data related to the bidders 30 or their bids, interrelationships between those bids, and any other bid related information or data that is received before or during the auction. Market feedback may include, for example, bids that have been placed by other bidders 30, the rank of a participants bid in relation to one or more other bidders 30, the identity of bidders 30, or any subset of that information. Market feedback may also include non-pricing information such as, for example, the quality of the goods to be provided by bidders 30 and shipping costs associated with one or more bidders 30. Providing such market feedback to bidders 30 in an auction helps create real-time competitive interaction among participants in the auction because, without feedback, bidders 30 who are not leading in an auction might not be aware or their relative position and would have less incentive to revise their price quotes and place additional bids to remain competitive.

After the auction, the auction coordinator 20 may analyze the auction results with the sponsor 10. The sponsor 10 typically conducts final qualification of the low bidding supplier or suppliers 30. The sponsor 10 may furthermore retain the right not to award business to a low bidding supplier 30 based on final qualification or other business concerns. As shown in FIG. 1C, at least one supply contract is usually drawn up and executed based on the results of the auction.

The auction may be conducted electronically between bidders 30 at their respective remote sites and the auction coordinator 20 at its site. In an alternative embodiment, instead of the auction coordinator 20 managing the auction at its site, the sponsor 10 may perform auction coordinator tasks at its site.

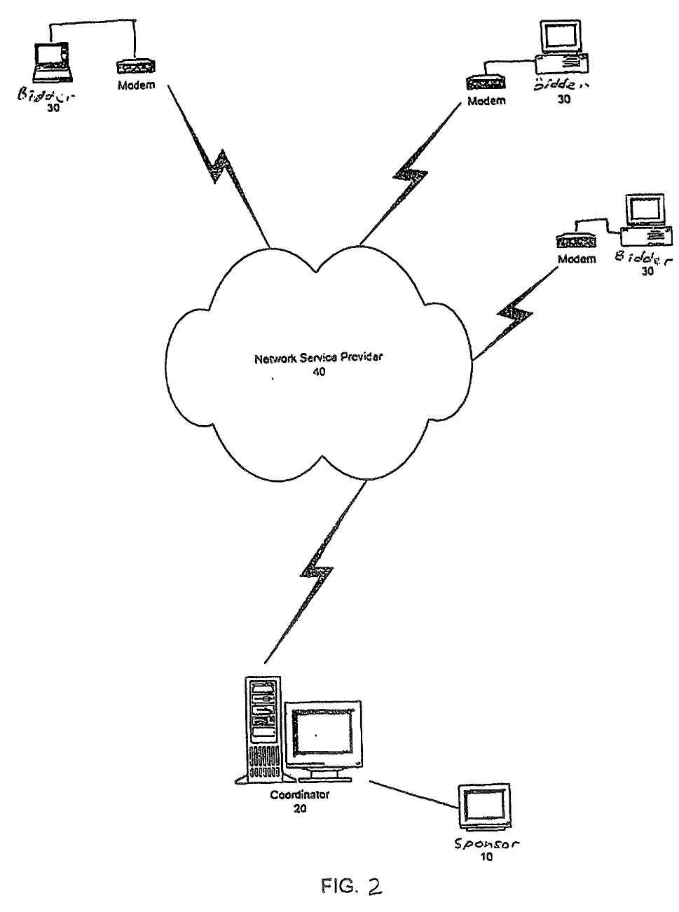

Information may be conveyed between the coordinator 20 and the bidders 30 via any known communications medium. As shown in FIG. 2, bidders 30 may be connected to the auction through the Internet via a network service provider 40 accessed, for example, through a dial-up telephone connection. Alternately, sponsors 10 and bidders 30 may be coupled to the auction by communicating directly with the coordinator 20 through a public switched telephone network, a wireless network, or any other known connection method. Other methods of connecting sponsors 10 and bidder 30 and other communications mediums are known to those skilled in the art, and are intended to be included within the scope of the present invention.

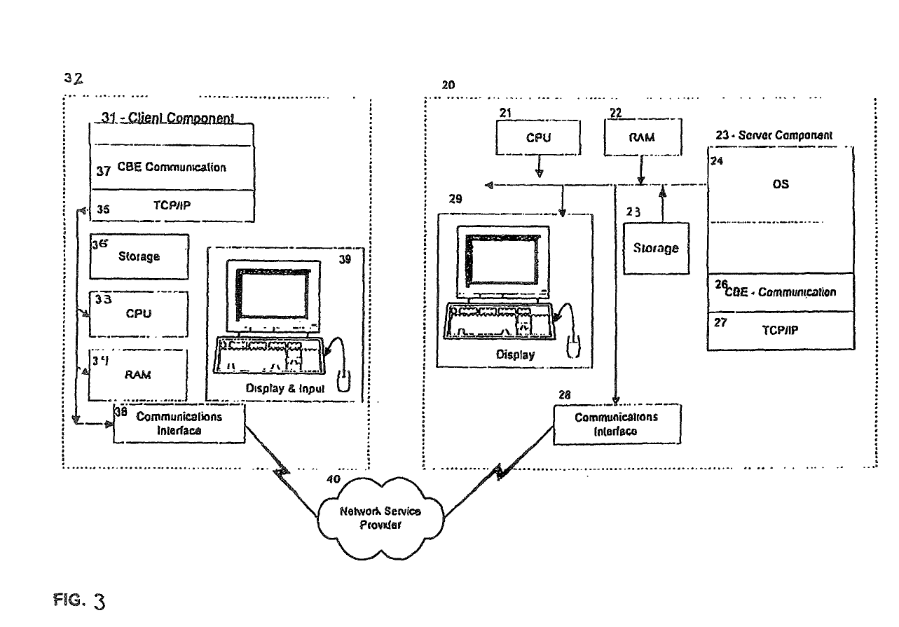

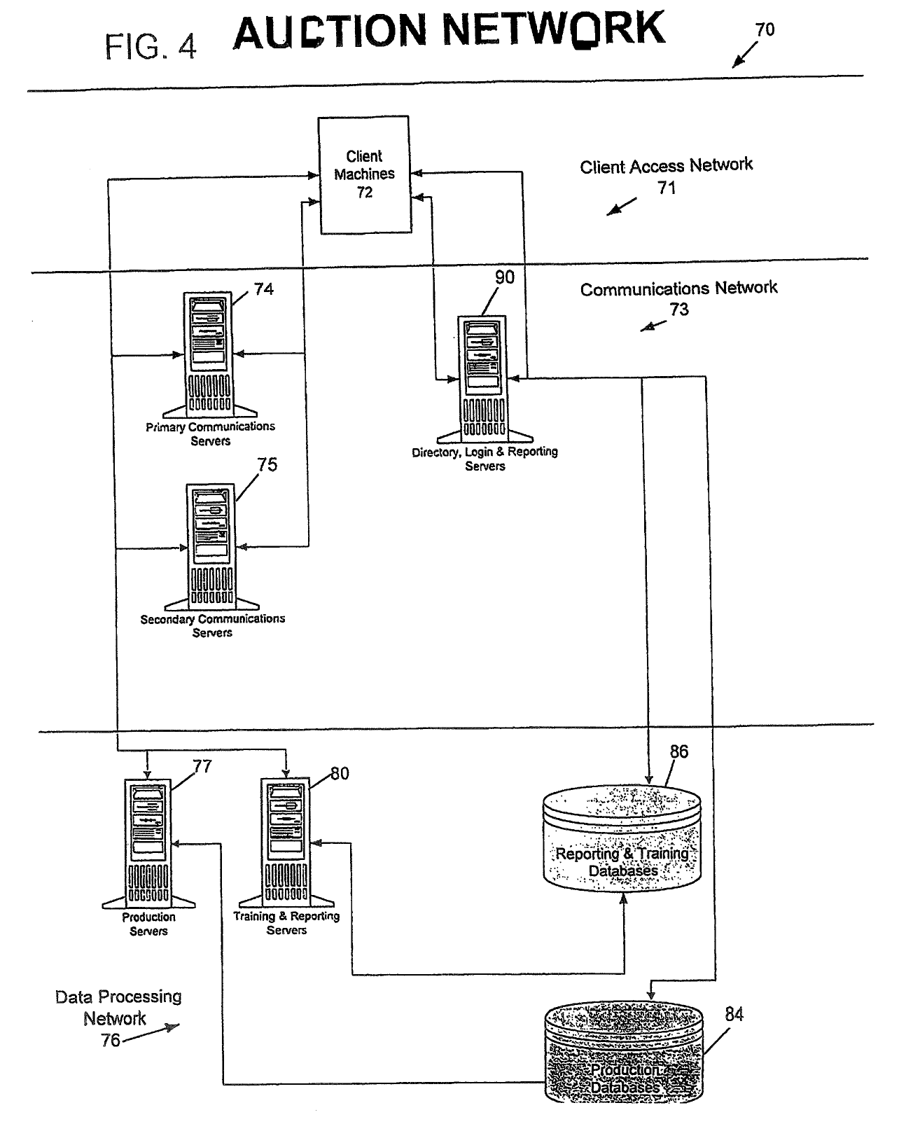

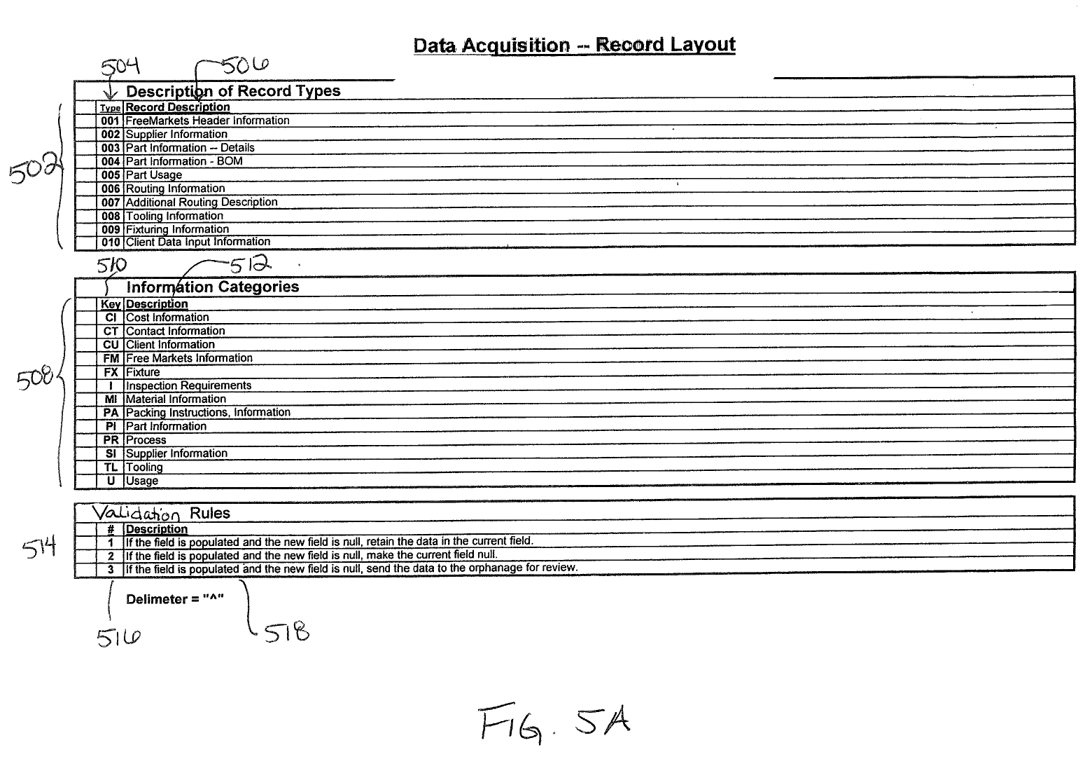

A computer software application may be used to manage the auction. The software application may include two components: a client component 31 and a server component 23. FIG. 3 illustrates a server component 23 and a client component 31 resident in host computers in a first embodiment. As may be seen in FIG. 3, the server component of that embodiment includes an operating system 24, competitive bidding event or auction communication software 26, and Internet protocol software 27. The server software is hosted on a computer 20 having a processor 21, random access memory 22, and a data storage facility 23. The host computer 20 also includes input and output devices 29 such as, for example a monitor, printer, mouse and keyboard, and a communications interface 28 for communicating with the client component 31. The client component of the embodiment illustrated in FIG. 3, includes competitive bidding event communication software 37, and Internet protocol software 35. The client component software is hosted on a computer 32 having a processor 33, random access memory 34, and a data storage facility 36. The host computer 32 also includes input and output devices 39 such as, for example a monitor, printer, mouse and keyboard, and a communications interface 38 for communicating with the server component 23.

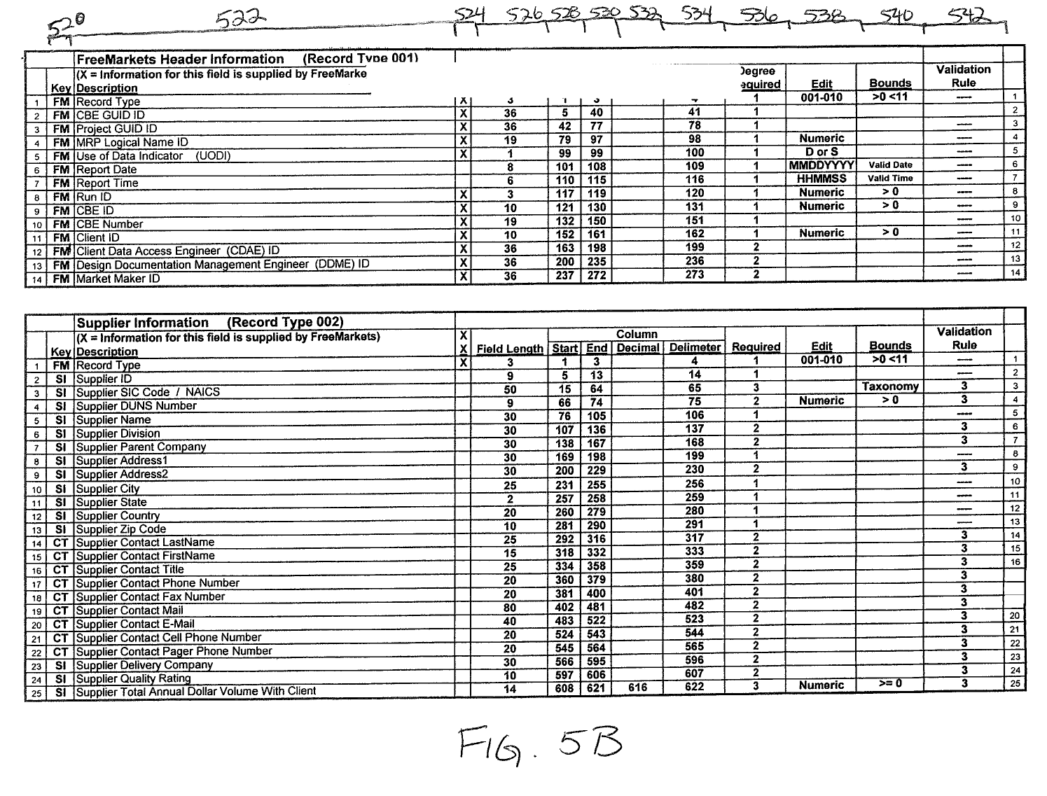

The client component 31 is used by the bidders 30 to make bids during the auction, and to receive and display feedback from the auction. The client component may, for example, be a program that is installed on a bidder's computer, or it may be software that is accessed and run from a Web site. Bids can typically only be submitted using the client component of the application, thereby ensuring that sponsors 10 cannot circumvent the bidding process, and that only invited suppliers 30 participate in the bidding. Each computer software application may be stored in a data storage device and executed by a processor such as those described in connection with FIG. 4 hereinbelow.

Bids are sent over the communications medium to, for example, the auction coordinator, or where the sponsor 10 is performing auction coordination tasks, directly to the sponsor 10. Bids are received by the server component 23. The client component includes software functions for making a connection over the Internet, or other medium, to the server component. Bids are submitted over this connection and feedback is sent to connected bidders 30.

When a bidder 30 submits a bid, that bid is sent to the server component and evaluated to determine whether it is a valid or acceptable bid. Feedback about received bids is sent to connected bidders 30 as is applicable, enabling bidders 30 receiving feedback to see changes in market conditions and plan competitive responses.

The embodiments described herein utilize an online reverse auction, wherein the auction is performed by a computer processor, as an example. In those examples, suppliers 30 bid to supply goods or services to a purchaser 10 and the purchaser 10 typically purchases the goods or services from the lowest priced qualified bidder 30. It is to be understood, however, that the auction would not necessarily have to occur online, and may be performed by other than a computer processor. The auction also need not be a reverse auction. For example, the auction may be advantageously a forward auction, wherein the party offering the highest priced qualified bid, rather than the lowest priced qualified bid, is awarded the goods or services being sold. In the case of a forward auction, the “leading bid” is the highest amount offered and the leading bidder 30 is the purchaser party 10 making that highest offer, while in a reverse auction, the “leading bid” is the lowest amount offered and the leading bidder 30 is the supplier party 30 making that lowest bid. Similarly, placing a “better bid” in a reverse auction indicates placing a lower bid, while placing a “better bid” in a forward auction indicates placing a higher bid.

FIG. 4 is a diagram illustrating an auction network 70 for operating an auction, and into which the server component 23 and client component 31 may be incorporated. The auction network 70 may be divided into three functional sections: a client access network 71, a communications network 73, and a data processing network 76. The client access network 71 may, for example, include one or more client machines 72 for accessing and communicating with the communications network 73. The communications network 73 may include one or more primary communications servers 74, secondary communications servers 75, and directory, login and reporting servers 90. The data processing network 76 may include production servers 77, training and reporting servers 80, reporting and training databases 86, and production databases 84. The production servers 77 and training and reporting servers 80 are referred to collectively herein as bid servers 77 and 80.

The client machines 72 may be, for example, personal computers and may be located at each bidder 30 and purchaser site 10 for accessing the auction. The client machines 72 may access the auction by, for example, connecting to a web site operated by the party hosting the auction. The client machines 72 may also receive software from the communications network 73 that facilitates communications with the communications network 73. Each client machine 72 may have a processor that executes applicable software, and a data storage device that stores applicable software and other auction data.

The primary communications servers 74 are utilized to provide information to bids 58 received from the client machines 72 to the bid servers 77 and 80, and to provide that bid information from the bid servers 77 and 80 to the client machines 72. The primary communications servers 74 may furthermore act as a firewall to prevent direct access to the bid servers 77 and 80 by the client machines. The secondary communications servers 75 act as backups to the primary communications servers 74. The secondary communications servers 75 will perform the communication functions normally performed by the primary communications servers 74 if a failure occurs in the primary communications servers 74, thereby providing redundancy to the auction network 70.

The directory, login, and reporting servers 90 may perform a variety of functions that may be performed by a single server or include separate servers for the various functions. The directory, login, and reporting servers 90 may include a web server that acts as a portal for access to the auction network 70. As such, the directory, login, and reporting servers 90 will receive login requests for access to the auction network 70 via, for example, the Internet. The directory, login, and reporting servers 90 may make access decisions as to whether a client machine 72 is permitted to access the communications network 73. If access is permitted, the directory, login, and reporting servers 90 will direct the client machine 72 to the appropriate portion of the auction network 70. The directory, login, and reporting servers 90, may provide reports to client machines 72. For example, information from prior auctions which may be utilized by purchasers 10 to make a decision as to which bidder 30 will be awarded the sale and to permit the purchaser 10 to consider the way in which the auction proceeded so that future auctions may be refined.

The production servers 77 run the bidding software that facilitates the auction process. The production servers 77 may communicate with client machines 72 through primary and secondary communications servers 74 and 75. The production servers 77 may also be redundant so that if a failure occurs in the production server 77 that is being utilized in an auction event, the redundant backup production server 77 may perform the functions of the failed production server 77 and, thus, prevent failure of the auction.

The training and reporting servers 80 operate in a manner similar to the production servers 77 and provide reports for auctions. It is useful to operate test auctions to test the operating systems and to train personnel and clients. Such testing may be performed on the production servers 77 or, to prevent any degradation of system operation in actual auctions, one or more separate training servers may be utilized for testing and training. Reporting may also be accomplished on the production servers 77 or the report creation functions may be offloaded to one or more reporting servers 80. The reporting servers 80 may furthermore be combined with the training servers 80.

Each server 74, 75, 77, 80, and 90 may have a processor that executes applicable software, and a data storage device that stores applicable software and data. It should be noted that, although the present invention is described in terms of a server component and a client component, one skilled in the art will understand that the present invention is not limited to a client/server program relationship model, and may be implemented in a peer-to-peer communications model or any other model known to those skilled in the art.

Data related to auctions may furthermore be held in one or more storage devices. The data storage devices may, for example, be a magnetic storage device, a random access memory device (“RAM”), or a read only memory device (“ROM”). The data may include pre-auction data, post auction data, and data that is related to active auctions. Pre-auction data may include, for example, suppliers 30 that are permitted to bid on a particular auction and the scheduled auction starting and ending times. Post auction data may include the bids and bid times received in a particular auction and reports displaying that data in user friendly formats. Active auction data may include data received from the bidders 30 as the auction is taking place and related data such as the rank of each bidder 30.

Three databases, or groupings of databases, are incorporated into the auction network illustrated in FIG. 4. The production databases 84 hold data that will be used by or is received from the production servers 77, while the reporting and training databases 86 hold data that will be used by or is received from the training and reporting servers 80.

The directory, login, and reporting servers 90 illustrated provide a web portal for the client machines 72. The directory, login, and reporting servers 90 provide an initial contact point for the client machines 72, access to auctions in which the client machine 72 is permitted to participate, and reports relating to active and closed auctions.

One skilled in the art will recognize that certain components of the network described herein, while beneficial to an auction network, are not necessary components in an operational auction network. For example, the secondary communications servers 75 could be removed where the benefit of redundancy is not desired, and the primary communications servers 74 could be removed and the client machines 72 could communicate directly with the bid servers 77 and 80.

### The BOM

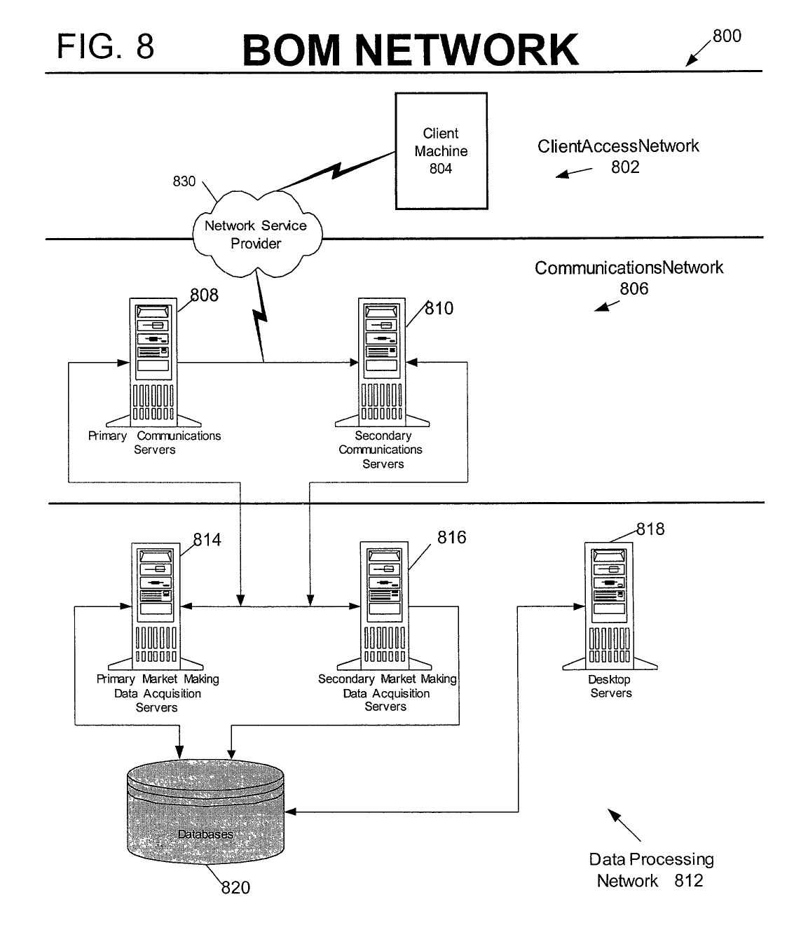

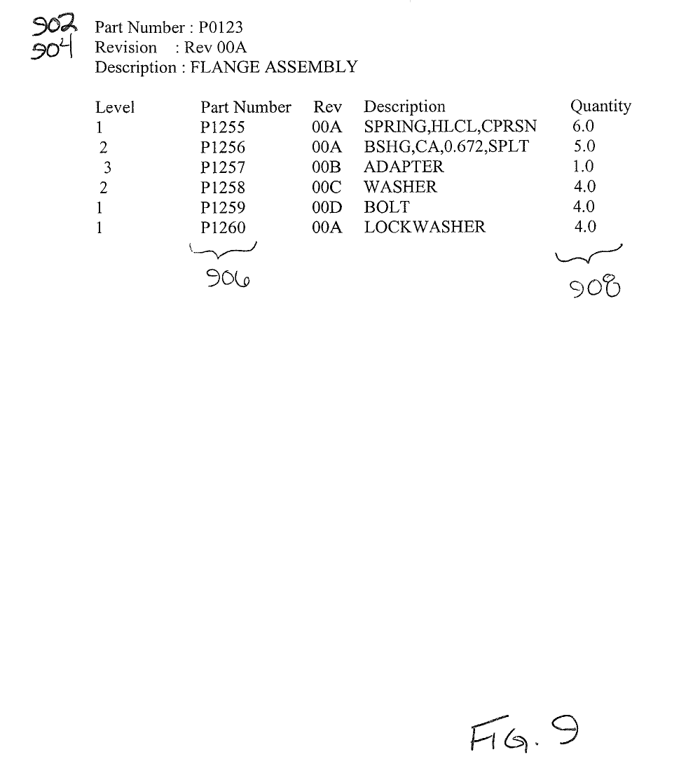

As discussed elsewhere herein, in one example, the BOM information may be included in an RFQ to be submitted in connection with an online auction. In the auction embodiment, the auction network described above may be connected with other systems used to generate the BOM, as described with reference to FIG. 8, which is a diagram illustrating a network 800 for operating the inventive system. The network 800 may be divided into three functional sections: a client access network 802, a communications network 806, and a data processing network 812. The client access network 802 may, for example, include one or more client machines 804 for accessing and communicating with the communications network 806. The communications network 806 may include one or more primary communications servers 808 and secondary communications servers 810. The data processing network 812 may include primary market making data acquisition servers 814 and secondary market making data acquisition servers 816.

The client machines 804 may be, for example, personal computers, through which the client, or organization 10, may access the organization's MRP system. The client machines 804 may access the network of the inventive system via the Internet through network service provider 830.

The primary communications servers 808 may act as a firewall to prevent direct access to the market making data acquisition servers 814 and 816 by the client machines. The secondary communications servers 810 act as backups to the primary communications servers 808. The secondary communications servers 810 will perform the communication functions normally performed by the primary communications servers 808 if a failure occurs in the primary communications servers 808, thereby providing redundancy to the network 800.

The primary market making data acquisition servers 814 perform the validating function, as well as the reconstructing the BOM function and generating the comprehensive BOM function of the present invention. Data received from or generated by primary market making data acquisition servers 814 may be held in, for example, a database such as one included in databases 820. Desktop servers 818 may then retrieve data from and send data to databases 820.

The network 800 may be connected to auction network 70 of FIG. 4 to allow data generated by the inventive system to be used in connection with, in one example, the online auction.

One skilled in the art will recognize that certain components of the network described herein, while beneficial to the inventive system network, are not necessary components in an operational network. For example, the secondary communications servers 810 and secondary marketing making data acquisition servers 816 could be removed where the benefit of redundancy is not desired.

The process of validating information contained in a BOM and of reconstructing a BOM using the validated information in accordance with a preferred embodiment of the present invention is described generally as follows. An organization, such as a sponsor 10, may create a flat file which is structured in accordance with a standardized template of the present invention and which includes the organization's part data (e.g. product assembly) information. The flat file may be stored on the organization's MRP systems, such a system accessible through client machine 804. The organization may then attempt to export the flat file through the communications network 806 to the data processing network 812 of the service provider which may be for example, the auction coordinator 20. Upon the exportation attempt, the flat file is subjected to a validation process in primary market making data acquisition servers 814 where it is automatically checked for errors. The validation process may result in the generation of log files containing information such as records found to be valid, records found to be invalid, and a description of any errors detected. The log files may be maintained in databases 820. The log files are reviewed and any errors detected must be corrected by the organization 10. Once the flat file has been checked for errors and any errors detected have been corrected, the flat file is prepared for re-exportation to the data processing network 812 via the communications network 806. One or more flat files may be generated, validated and exported to the service provider's systems. Once the flat file(s) are exported to the data processing network 812, a BOM can be reconstructed automatically by primary market making data acquisition servers 814. Automatic reconstruction of the BOM results in time and cost savings to the organization.

The neutral format of the flat file ensures compatibility with all systems. Therefore, because the flat file is standardized in accordance with the template, the flat file can be imported into the data processing network 812, and a BOM generated, no matter what type of system the organization 10 uses. Similarly, the organization 10 can aggregate product assembly information, creating a comprehensive BOM, across its various business units (e.g. divisions, departments, locations or plants), even if such business units use different systems, through use of the standardized template. Thus, an organization 10 can use one BOM for all of their product assemblies no matter which or how many systems are used within the organization 10. Aggregating BOM information in this way may allow the organization to achieve economies of scale in procuring parts necessary for the manufacture of its various product assemblies.

The BOM and comprehensive BOM automatically generated in accordance with the methods and systems of the present invention can be used, for example, in connection with preparation of RFQs for the organization.

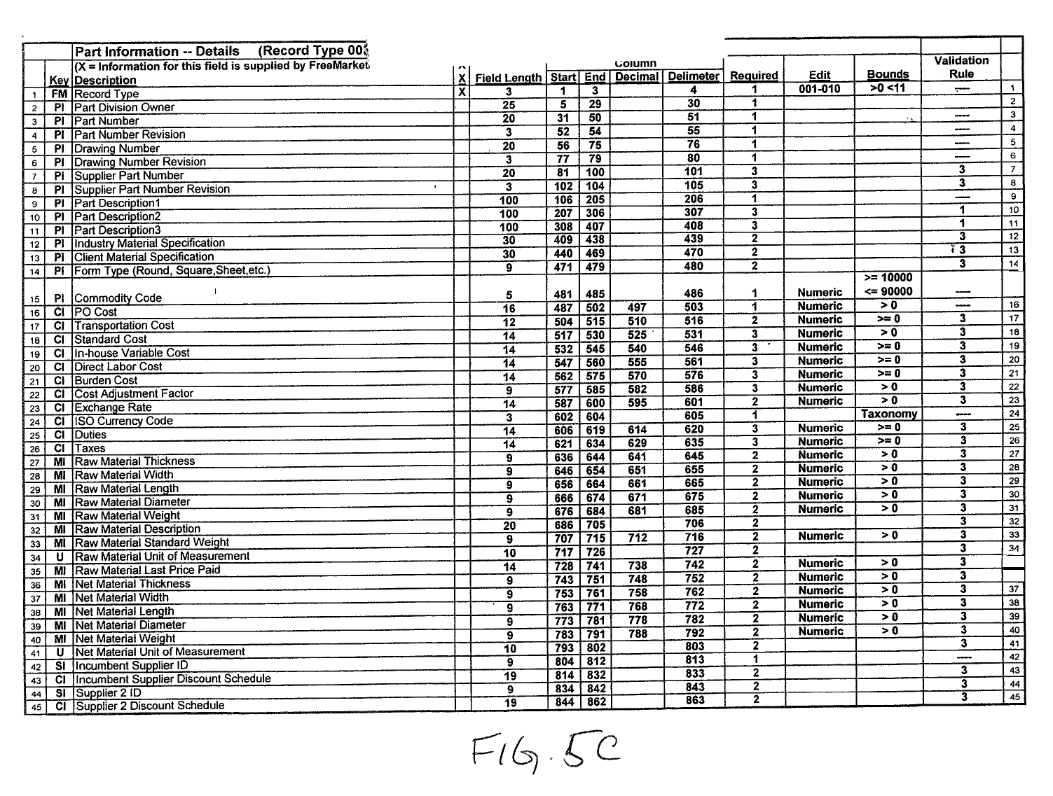

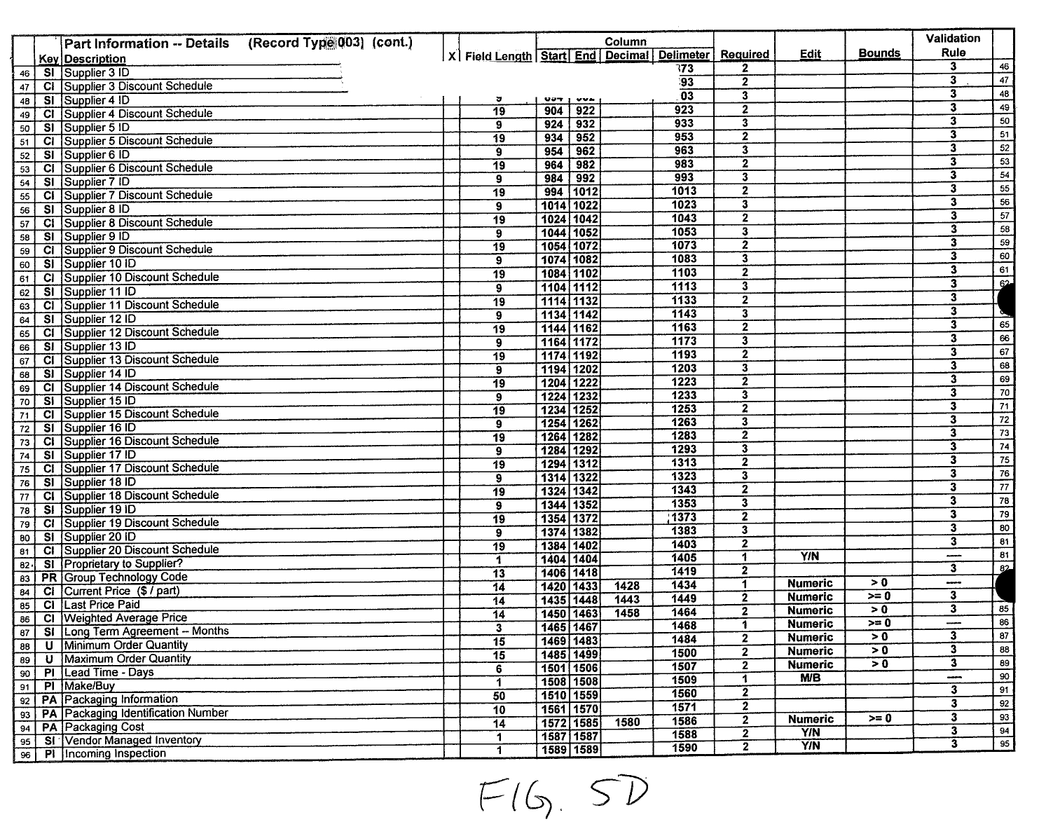

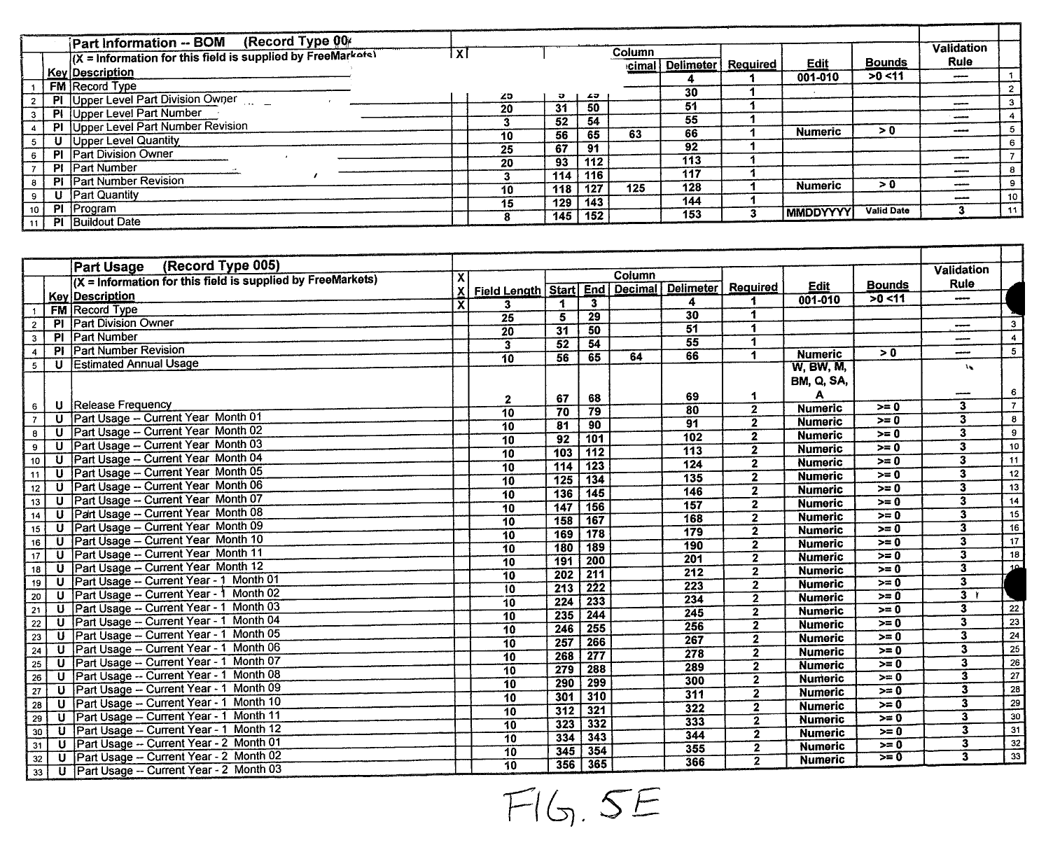

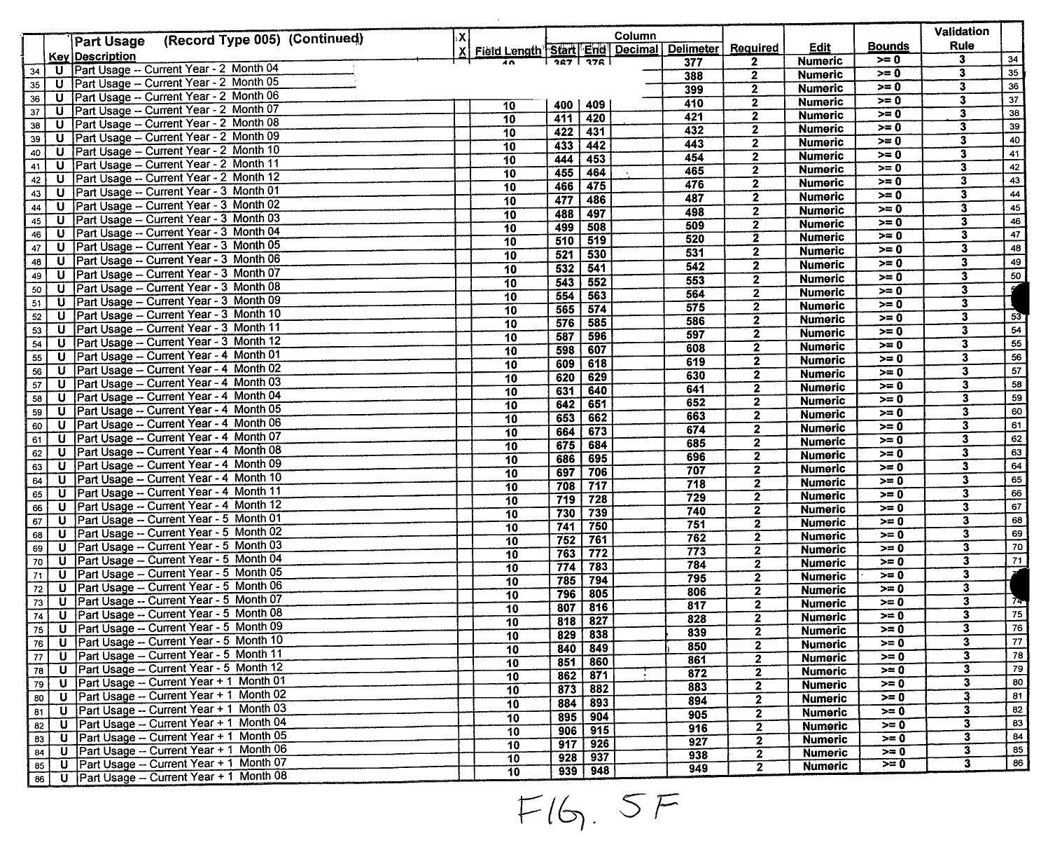

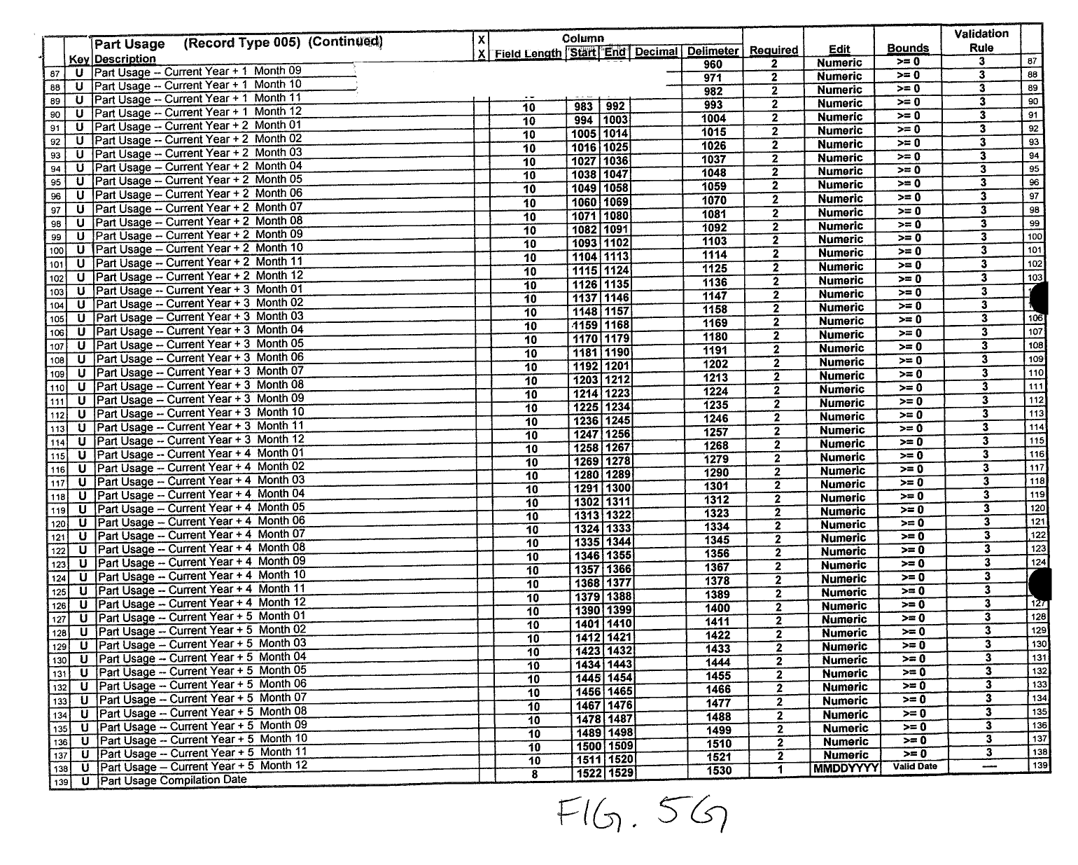

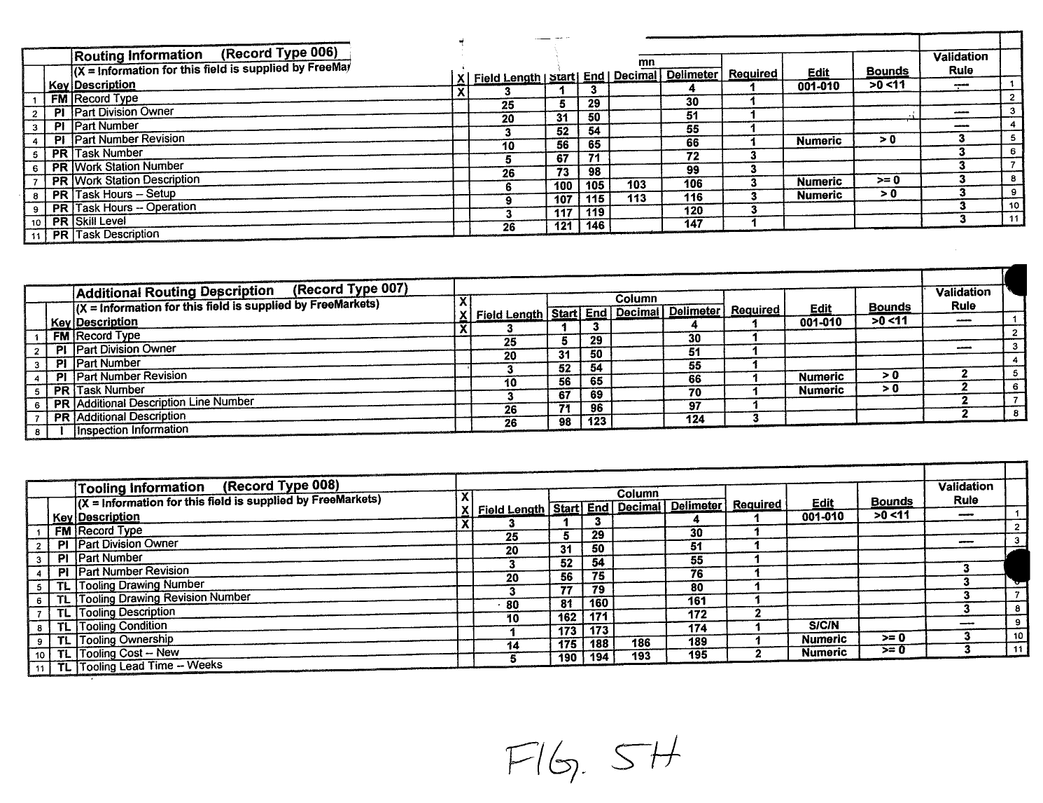

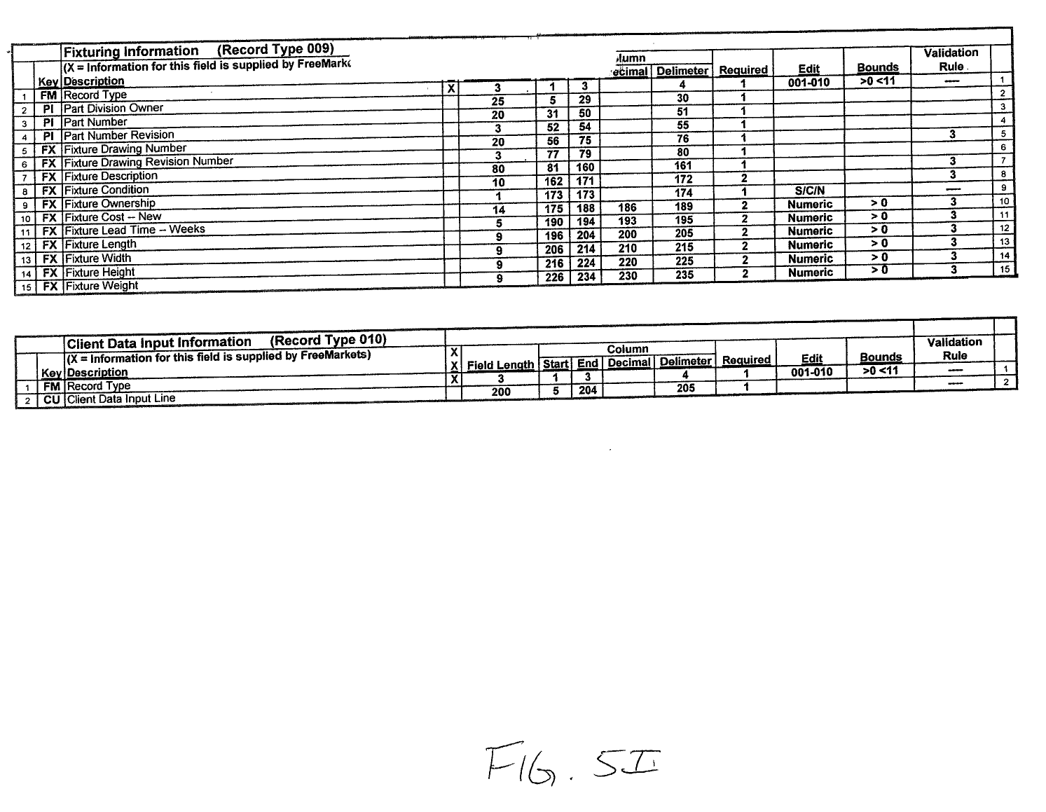

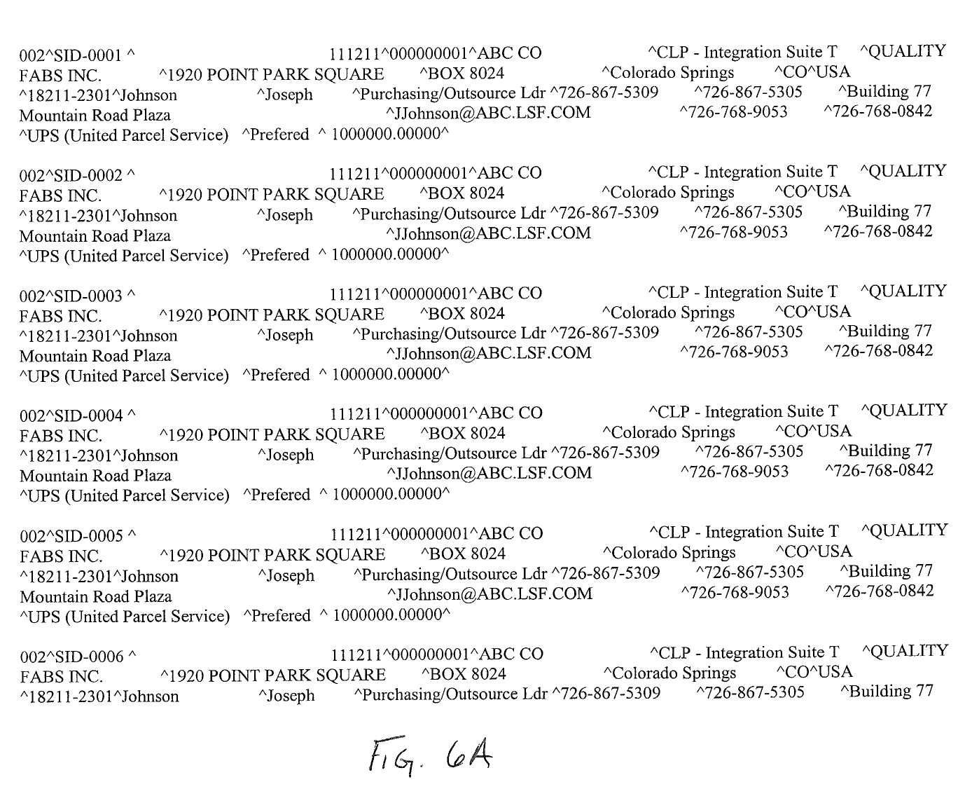

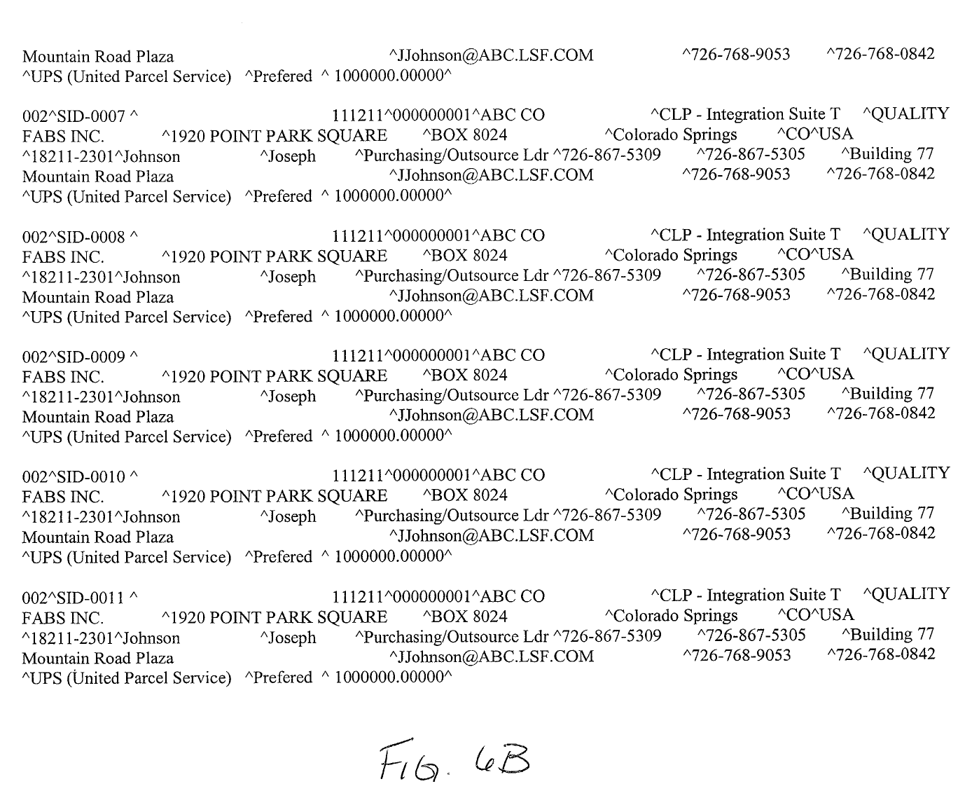

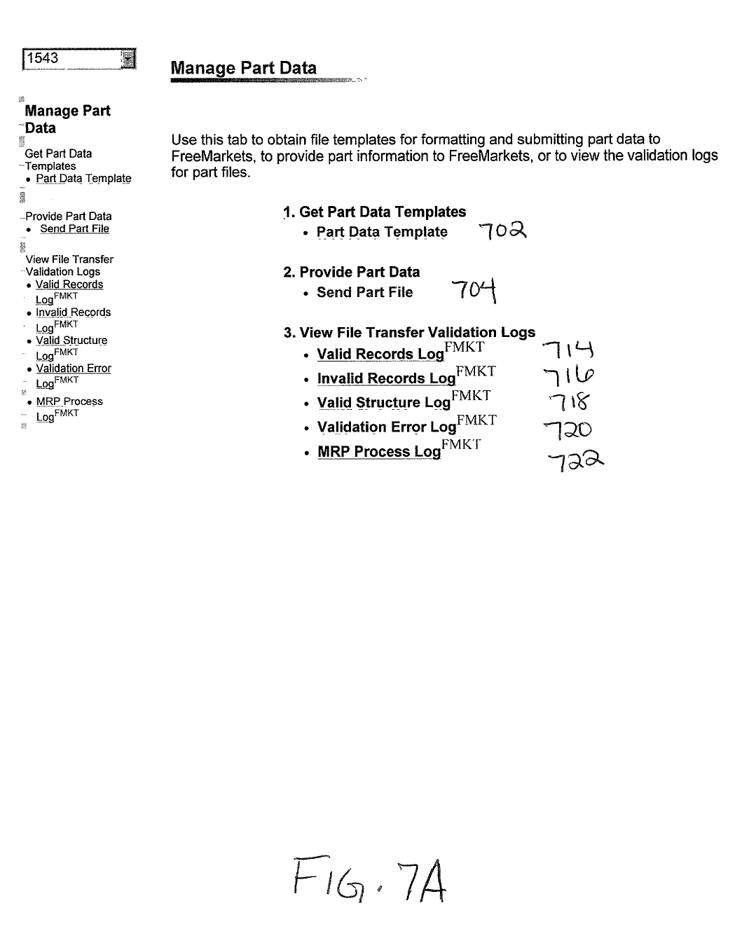

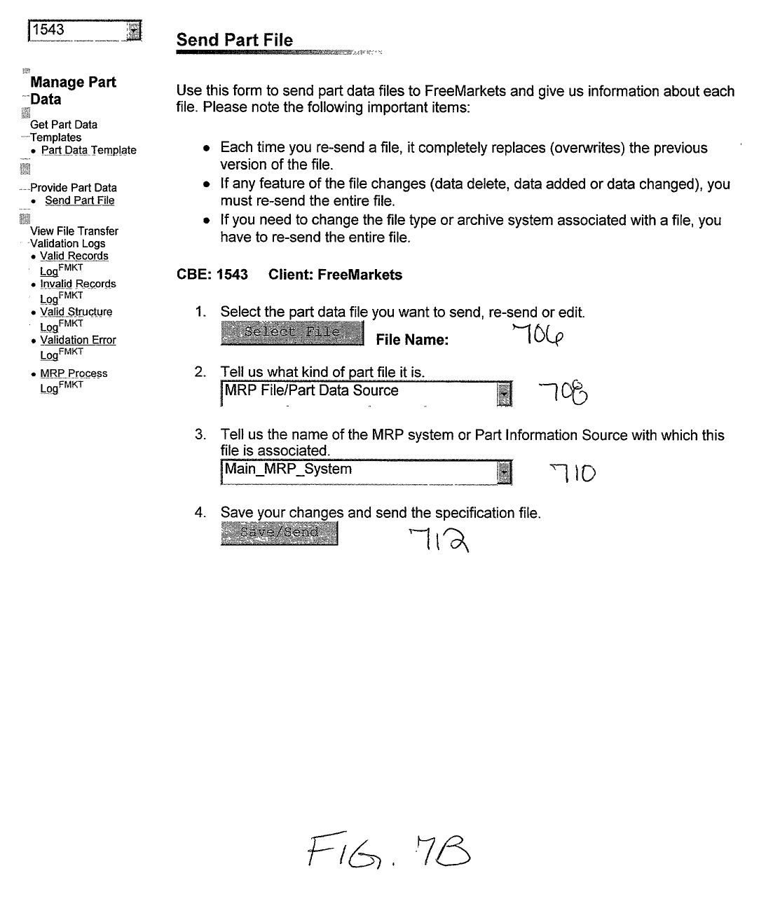

FIGS. 5A through 5I provide an example of the format of the standardized template, which is the structure used to create a flat file containing BOM information, of a preferred embodiment of the present invention. The standardized template can be obtained by the organization 10 via, for example, a web site hosted by the service provider 20. With reference to FIG. 7A, the organization can click on part data template section 702 to link to the standardized template, an example of which is shown in FIGS. 5A through 5I.

The example shown in FIG. 5A includes ten record types, as shown in description of record type area 502, each of which has a record type number 504 and a record description 506. Each record type includes various information categories 508, each of which includes a key 510 and associated description 512. Also included are validation rules 514, each of which is assigned a number 516 and associated description 518. The validation rules provide direction as to what to do in the event the organization sends a series of flat files to the service provider and a later-sent file contains information for a particular field which is inconsistent with information for the same field included in an earlier-sent file. A greater or lesser number, or different record types, information categories and validation rules may be used.

With reference to FIGS. 5B through 5I, the specific key information in column 520 and information categories in column 522 are shown for each record type. In column 524, an “X” indicates that the information for that information category is to be provided by the service provider such as the auction coordinator 20. All information categories not including an “X” in column 524 must be completed by the organization 10. In column 526, the length of the information category field, by number of characters, is provided. Columns 528 and 530 show where each field begins and ends, respectively. Column 532 informs as to whether a decimal point is included and, if so, its location in the field. Column 534 informs of the location of the delimeter, which indicates where one information category ends and another information category begins. The degree required is set forth in column 536 and provides information as to the importance of information contained in a particular field. Edit column 538 describes the format of the data for each particular information category. For example, if a particular information category requires numeric data, the space in edit column 538 corresponding to that information category includes a “numeric” indication. If, for example, a particular information category requires date or time data, the space in edit column 538 corresponding to that information category includes a “MMDDYYYY” or “HHMMSS” indication, respectively. If, for example, the information category requires only specified numbers, the particular numbers are specified in edit column 538. An information category which requires a letter indication, for example “Y” or “N” for “yes” or “no”, will indicate “Y/N” in edit column 538. Bounds column 540 provides information, for example, as to whether data for a given information category requires numbers within a certain range, a valid date or time, or a particular nomenclature, such as a code format. Validation rule column 542 requires data corresponding to the validation rules, discussed with reference to FIG. 5A, for the particular information category. Thus, the structure of the standardized template corresponds to the manner in which the BOM information is to be inputted into the flat file.

A description of the information contained in each record type in a preferred embodiment of the present invention is as follows. More, less or different information may be included in these record types in other embodiments of the present invention. The first entry of each record is a numeric code which informs the service provider 20 as to the identity of the record type, thereby dictating the format (as described with reference to FIGS. 5B to 5I herein) of the data included in the record. Record type one includes information supplied by the service provider 20 for use in connection with its internal record keeping activities.

Record type two includes information regarding the part supplier, such as the identification number assigned to the supplier by the organization 10; the industry standard code identifying the supplier; DUNS Number (an internationally recognized common company identifier in the EDI and global electronic commerce transactions); the name of all suppliers that have supplied the part in the past; division name and parent company; address information; contact information; delivery company used by the supplier; quality rating assigned to the supplier by the organization 10; and total annual dollar value for all parts produced by the supplier for the organization 10 on an annual basis.

Record type three includes information about a particular part in the subject assembly. The information included in record type three includes the business unit within the organization which owns the part; number assigned to the part; revision level of the part number; engineering number assigned to the item being processed; revision level of the drawing number; number assigned by the supplier for the part; revision level of the supplier part number; descriptions of the part; industry standard and client specification used to describe the material from which the part is made; shape of material used to manufacture the part; commodity code (industry assigned value describing the type of economic good being produced); price as shown on the last purchase order (“PO”) issued for the part; cost to deliver the part to the designated location; cost currently being used by the organization to determine the overall cost of the part; variable cost associated with the part; labor cost associated with the part; burden cost (to compensate for fixed expenses); cost adjustment factor (to adjust for expenses internal to the organization); rate of exchange from one currency to another; ISO currency code (international indicator of what type of currency is being used); duties paid for transporting a part from one country to another; taxes charged by the state or country for the given part; the dimensions, weight, description, standard weight and unit of measurement of the raw material from which the part is made; the last price paid by the organization for the raw material used to manufacture the part; the final dimensions and weight, and unit of measure of the part as manufactured; identification number assigned to the current supplier of the part and any discount arrangements between the organization and the current supplier; identification number assigned to past suppliers of the part and any discount arrangements between the organization and the past supplier; information as to whether the supplier holds exclusive rights to the part; the identification number that describes the geometry and attributes of the part; price currently being paid, and the immediately preceding price paid, by the organization for the part; the average price paid, taking into consideration multiple supplier's producing the item; the number of months remaining before the contract between the present supplier and the organization expires; the minimum and maximum number of parts that can be produced economically at one time; the elapsed time in days that it takes to produce the item, including procurement of the material; whether the organization is currently manufacturing the part in-house or purchasing the part from a supplier; packaging requirements, identification number and cost; whether the supplier places the item on the organization's production floor; and whether the organization performs an inspection of the parts when they arrive at the organization's facility.

Record type four contains information regarding the parts used in a particular assembly and the relationship between these parts. In particular, this record type includes the number assigned to the upper level (i.e. “parent”) part, or assembly, of which the current item (i.e. the part that is the subject of the record, the “child”) is a part. Thus, the upper level (or parent) part refers to the higher level structure, or assembly, of which the current item (the child) is a part. In addition, the current item can be a parent part in and of itself if there is no higher level structure, or assembly, of which the current item is a part. Information such as the business unit that owns the upper level part and the upper level part number is also included in record type four. In addition, the quantity of upper level parts (or assemblies) required is included in record type four. Also included is the part number, part revision number, and part division owner of the current (child) item. The quantity of parts (children) required for inclusion in the upper level part (or assembly) is also included. The organization program name for which parts are produced, and the date by which the program runs out of production, is also included.

Record type five contains information regarding usage of the part that is the subject of the record. In particular, record type five contains information regarding the identity of the business unit that owns the part; the number assigned to the part and revision level of the part number; the estimation of how many of the particular part will be ordered annually; the frequency with which the parts are to be released; the quantity of parts expected to be used for certain specified period; and the date such part usage information was compiled.

Record type six contains information regarding the routing of the part that is the subject of the record which describes how and how long it will take to produce the part. In particular, record type six contains information regarding the identity of the business unit that owns the part; the number assigned to the part and revision level of the part number; the numeric sequence of the task or operation necessary to be performed in order to complete the part; the code representing the physical machine/area used to process the part; a description of the physical machine/area used to process the part; the hours necessary to prepare the machine/area for the operation needed to be performed by the part; the hours necessary to perform the work necessary to complete the part; the degree of training required to perform the work necessary to complete the part; and the description of the work necessary to be performed in order to complete the part.

Record type seven contains additional routing information regarding the part that is the subject of the record. In particular, this record type contains information regarding the identity of the business unit that owns the part; the number assigned to the part and the revision level of the part number; the numeric sequence of the task or operation necessary to be performed in order to complete the part; additional description of the work necessary to be performed in order to complete the part; the counter used to indicate the sequence in which the additional description items will be performed; and critical to quality (“CTQ”) characteristics information needed to insure the production of highest quality items.

Record type eight contains information regarding tooling of the part that is the subject of the record. In particular, this record type contains information regarding the identity of the business unit that owns the part; the number assigned to the part and the revision level of the part number; the drawing number used to identify special tooling needed to perform the required task; the revision level of the tooling drawing number; the description of the special tooling needed to perform the required task; the current evaluation of the amount of wear the tooling encountered in performing the task, which is used to evaluate how long the current tooling will be usable; an indication as to who owns the tooling; the cost in dollars of the tooling at the time it was originally purchased; and the elapsed time, in weeks, that it takes to produce the required tooling.

Record type nine is contains information regarding the fixture (i.e. an item used in the manufacture of the part) of the part that is the subject of the record. In particular, this record type contains information regarding the identity of the business unit that owns the part; the number assigned to the part and the revision level of the part number; the drawing number used to identify special fixture needed to perform the required task; the revision level of the fixture drawing number; the description of the special fixture needed to perform the required task; the current evaluation of the amount of wear the fixture encountered in performing the task, which is used to evaluate how long the current fixture will be usable; an indication as to who owns the fixture; the cost in dollars of the fixture at the time it was originally purchased; the elapsed time, in weeks, that it takes to produce the required fixture; and the dimensions and weight of the fixture.

Record type ten is contains client data input information, which is the data that the organization uses as input to the program that generates the MRP data. This information is used to enable the system of the organization 10 to run the report at a later date using the same input information.

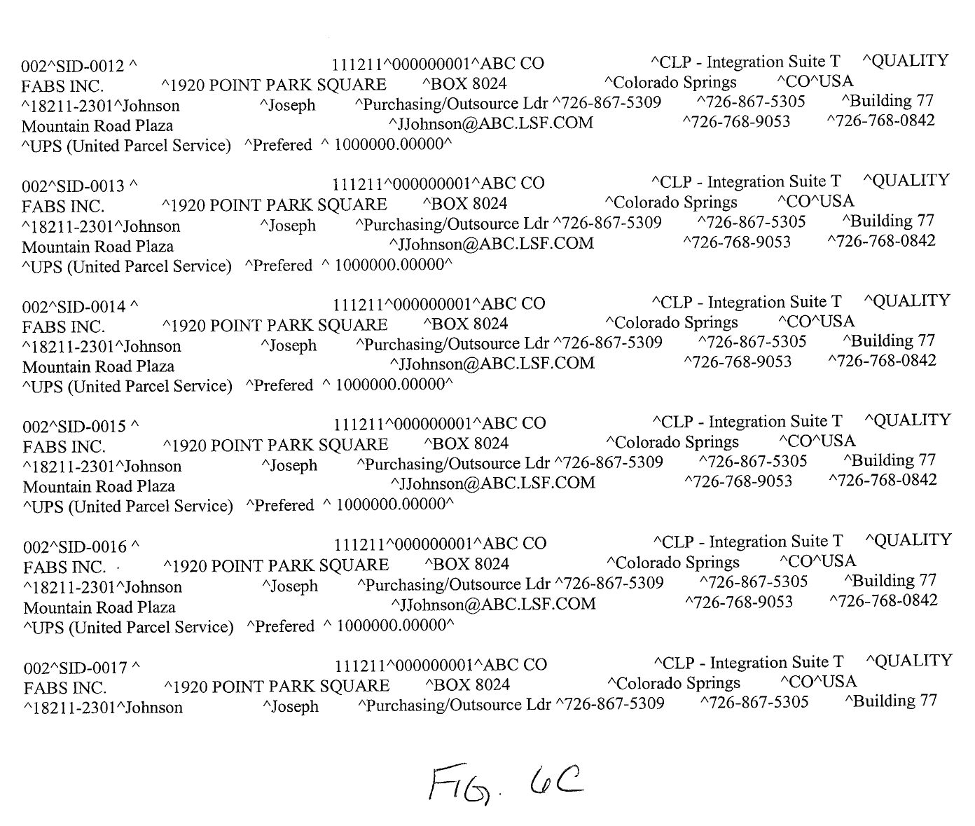

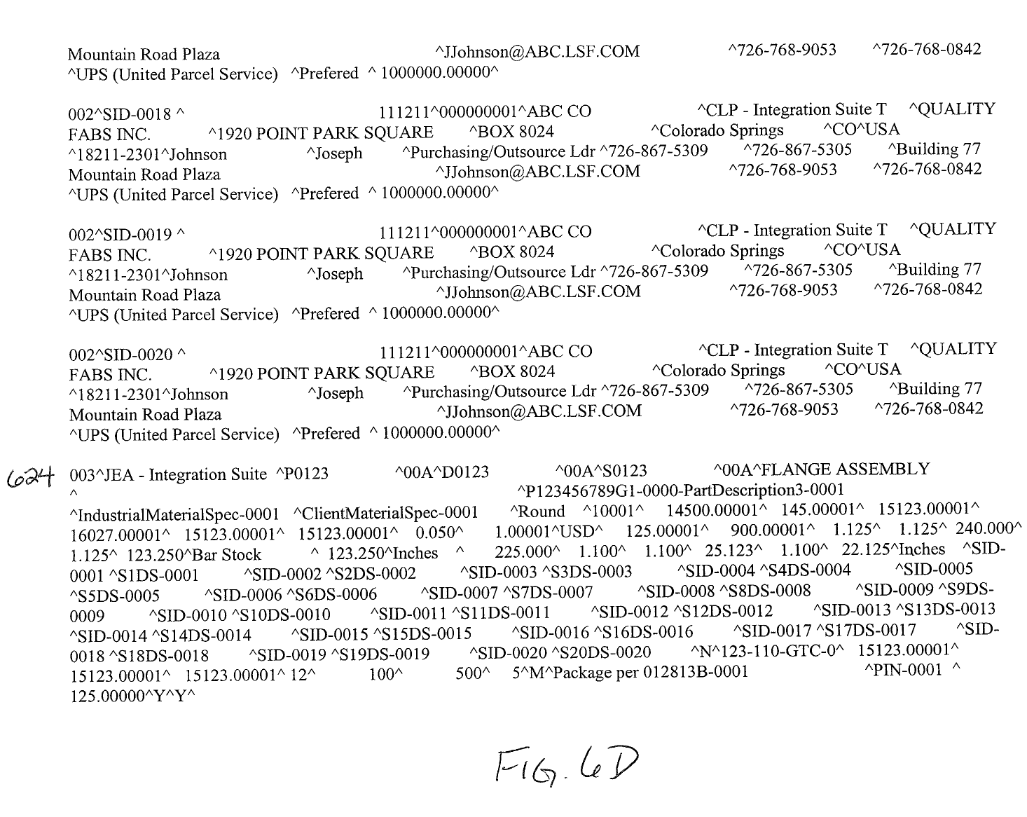

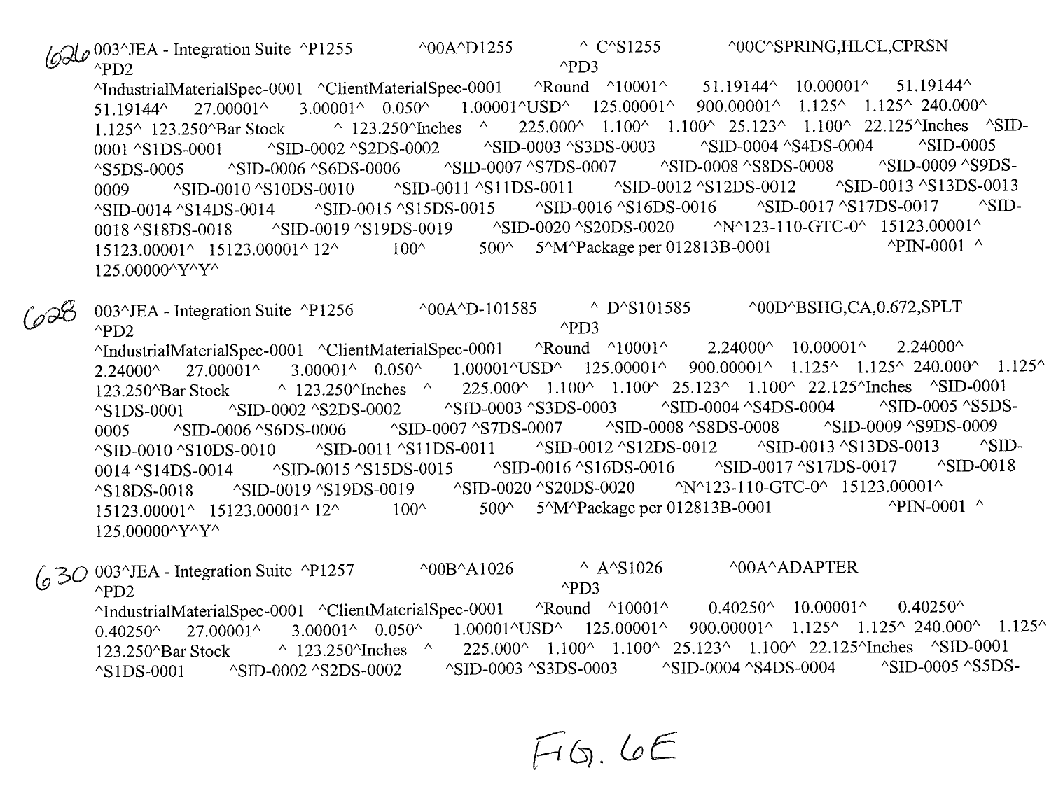

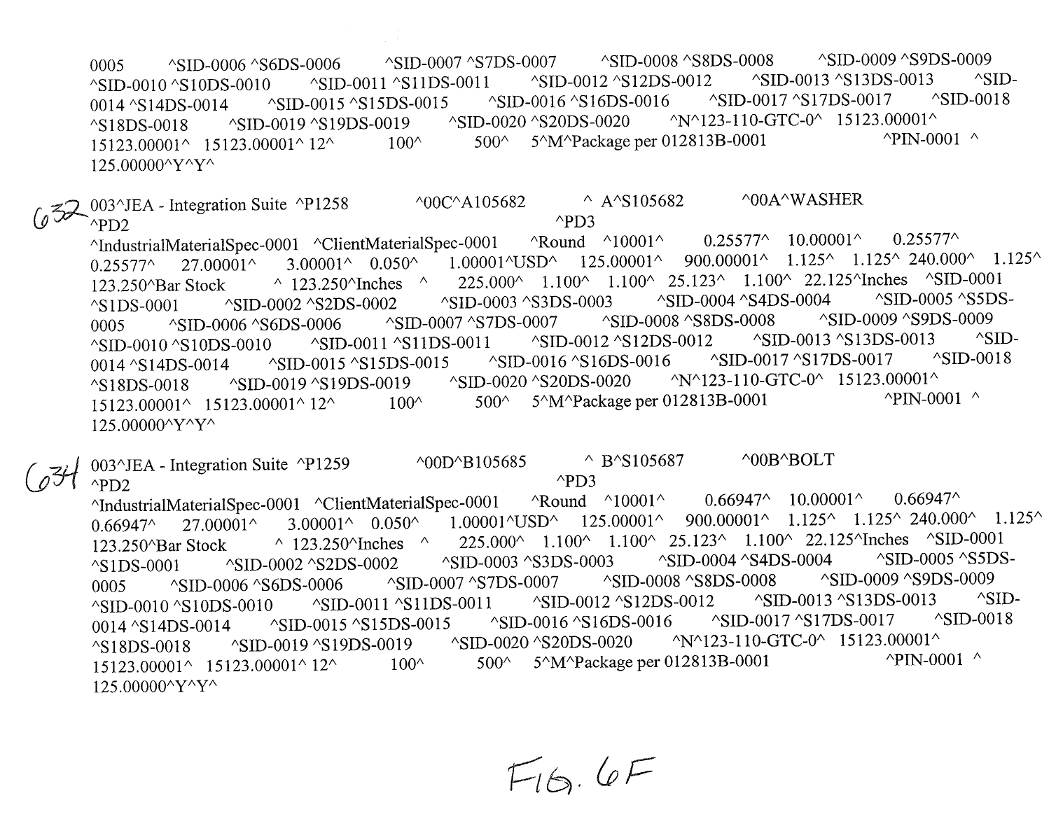

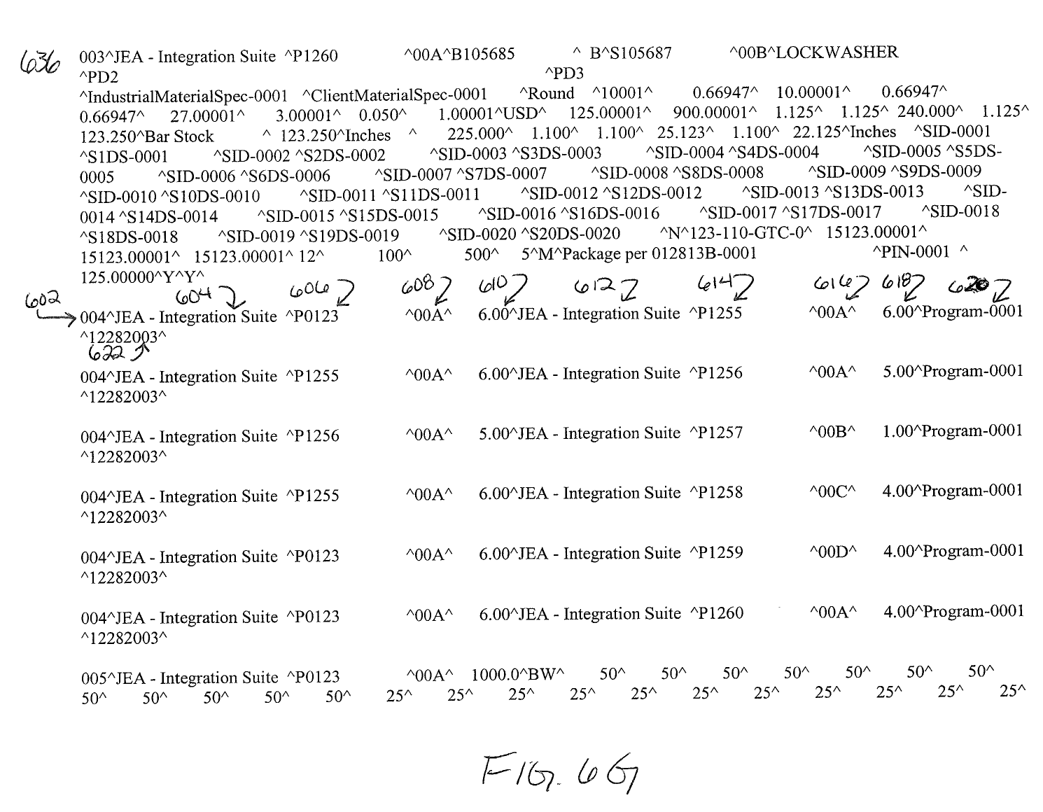

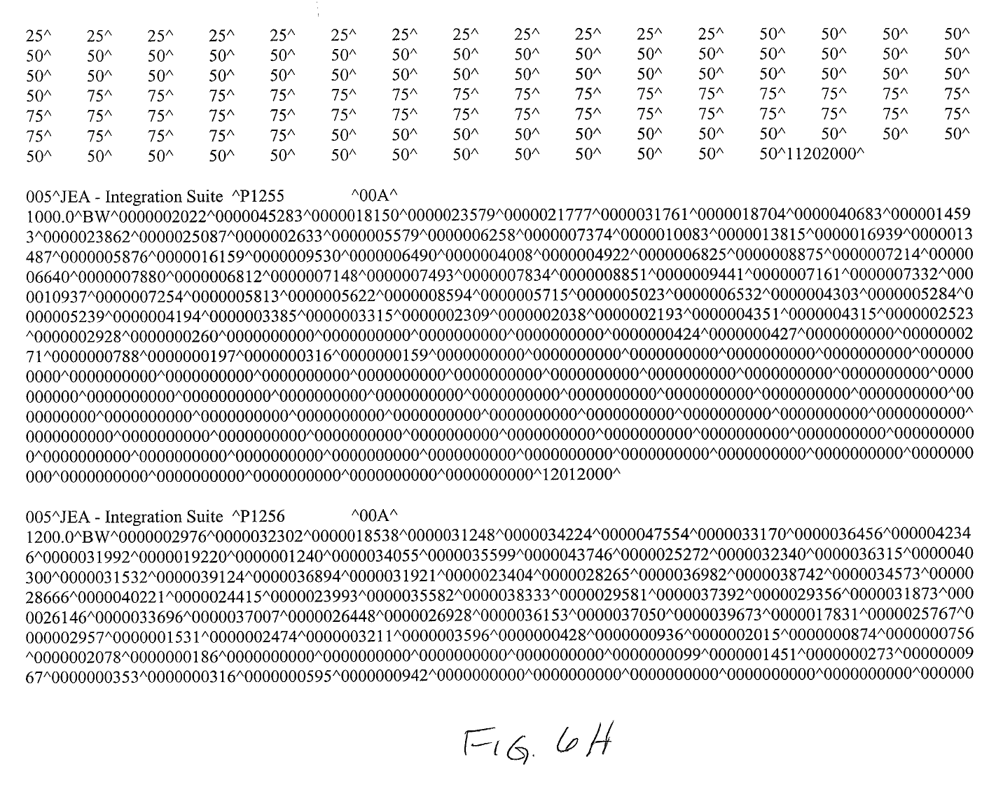

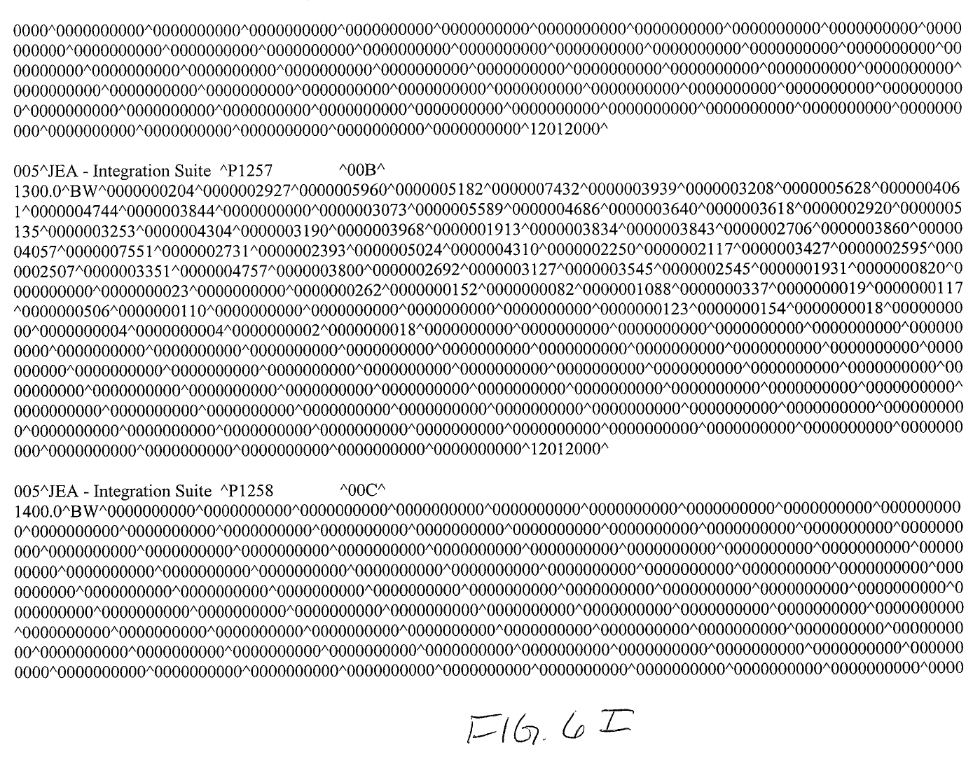

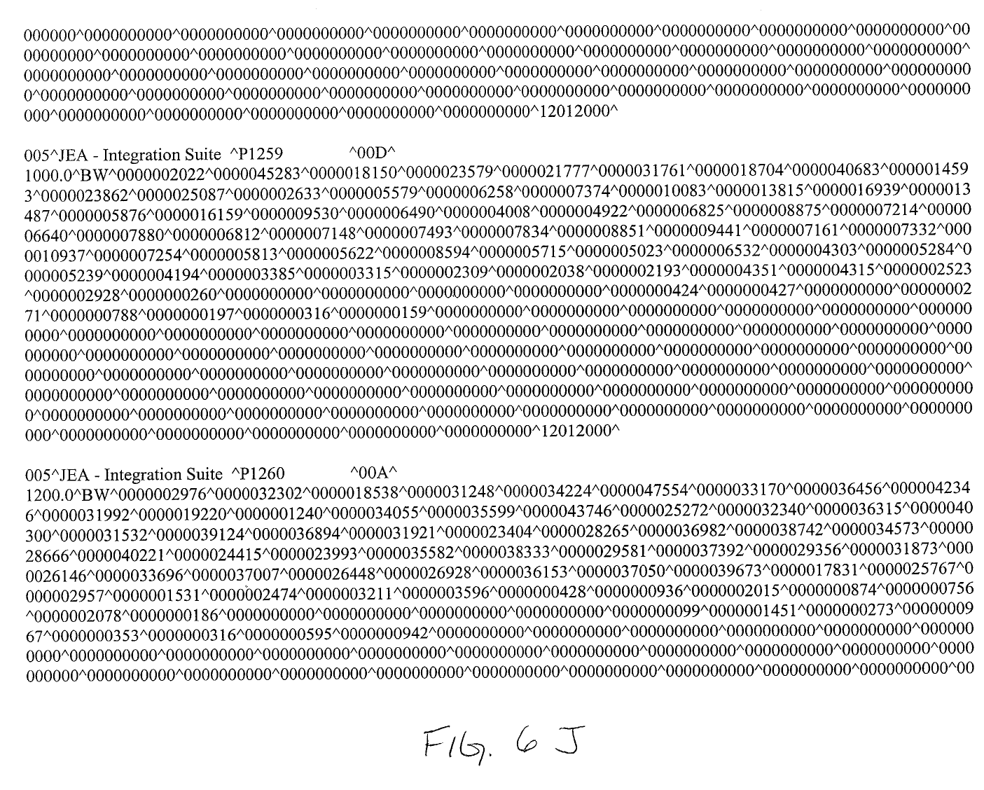

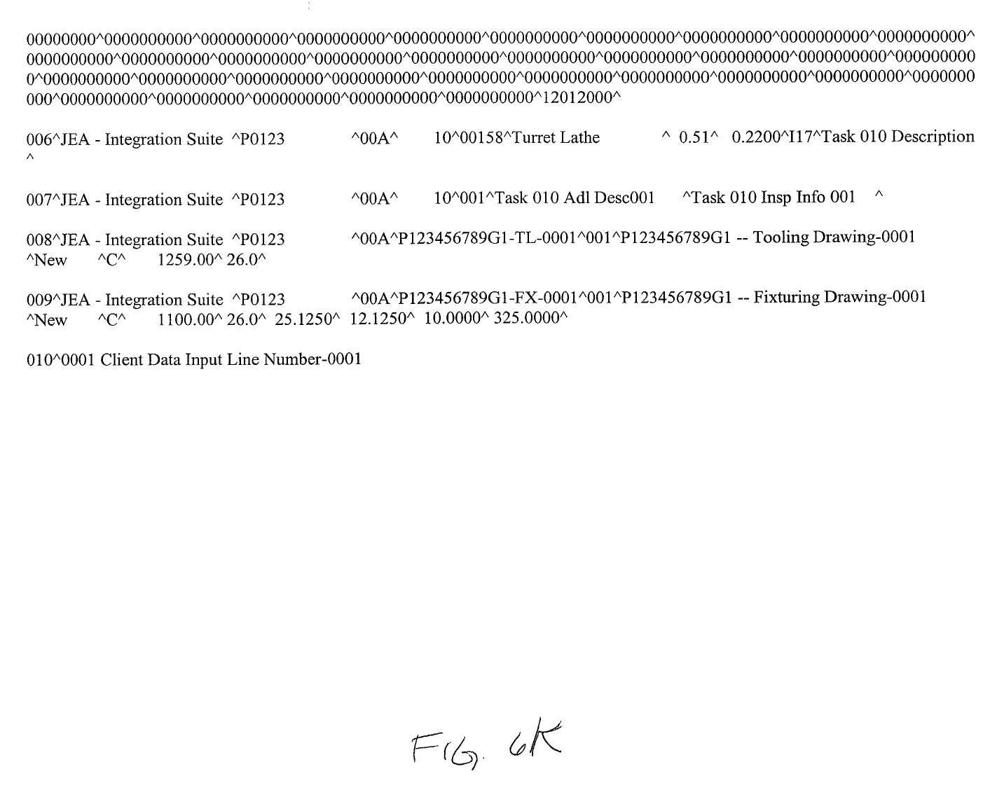

The organization 10 inputs the data for a particular product assembly in accordance with the standardized template, the substance and format of which is described above, thereby generating a flat file, such as an ASCII file, for use in accordance with the systems and methods of the present invention. FIGS. 6A through 6K show a print out of an exemplary ASCII file with data formatted in accordance with the standardized template. Thus, for example with reference to FIG. 6G, area 602 refers to the record type for the particular record, in this case record type four; area 604 refers to the upper level part division owner; area 606 refers to the upper level part number; area 608 refers to the upper level part number revision; area 610 refers to the upper level part quantity; area 612 refers to the part division owner; area 614 refers to the part number; area 616 refers to the part number revision; area 618 refers to the part quantity; area 620 refers to the program name towards which the part is produced; and area 622 refers to the date by which the program runs out of production. This exemplary ASCII file may be saved on, for example, the organization's MRP system accessible through the client machine 804. Multiple ASCII files like that shown in FIGS. 6A through 6K can be created for other of the organization's product assemblies in accordance with the standardized template shown in FIGS. 5A through 5I and similarly maintained on the organization's MRP system.

Once the flat file has been created by the organization 10 in accordance with the standardized template and saved on the organization's MRP system, the organization 10 must export the file into the system of the service provider 20. This can be done, in one embodiment, by accessing the service provider's system web site hosted on primary market making data acquisition servers 814.

With reference to FIG. 7A, depicting an exemplary web page of the service provider's web site, the organization may click on send part file area 704 and link to the send part file page, as shown in FIG. 7B. The organization selects the part data file it wants to export to the service provider's system in file selection area 706. The organization then selects the type of file (e.g. an MRP file) in area 708 and inputs the name of the file type system (e.g., SAP or Oracle) in area 710. By clicking on send file area 712, the ASCII file is exported to the service provider's 20 system. The validation process commences automatically upon the service provider's receipt of the ASCII file at primary market making data acquisition servers 814. One or more ASCII files may be sent by the organization to the service provider.

The service provider receives the ASCII file, may optionally perform a virus check, and commences the validation process. The validation process involves checking the ASCII file for, in one example, data field integrity and record order as well as whether the file contains valid BOM information and has met the inter-record dependency requirements.

Thus, in accordance with an embodiment of the validation process of the present invention, with reference to FIGS. 5A through 5I, the inventive system first checks the degree required field 536. If the degree required for a particular field is “1”, the organization must provide information for that field and the data provided must be correct; meaning, in one embodiment, that the data must conform to the specified field length 526, start point 528, end point 530, decimal placement 532, delimiter placement 534, edit format 538, and bounds information 540. If the information is missing or the data is incorrectly formatted, an error will be generated and the data will be copied to an invalid records log, as discussed in more detail below. If the degree required for a particular field is “2” and the organization fails to include the information or the data is formatted incorrectly, a warning will be generated and the data will be copied to an invalid records log. If the degree required for a particular field is “3” and the organization fails to include the information or the data is formatted incorrectly, no error or warning is generated and no data is copied to an invalid records log.

In an exemplary embodiment, for the data that remain after the degree required checks are performed, the validation rules field 542 must be checked. The validation rules are applicable if the organization sends a series of flat files to the service provider and a later-sent file contains information for a particular field which is inconsistent with information for the same field included in an earlier-sent file. Thus, for example, if the validation rule number is “3”, and a later-sent file contains information for a particular field which is inconsistent with information for the same field included in an earlier-sent file, an error is generated and the data in the field is copied to an invalid records log; if the validation rule number is “2”, the data from the earlier-sent file is replaced with the data contained in the later-sent file; and if the validation number is “1”, the data from the earlier-sent file remains and the data contained in the later-sent file is ignored.

In an exemplary embodiment, for the data that remain after the degree required and validation rules checks are performed, the inter-record dependency requirements must be checked. One type of inter-record dependency requirement pertains to the part hierarchy information contained in each of the record type fours. Part hierarchy information refers to parent-child relationships between the various parts of an assembly. For example, each assembly may comprise one or more parts; each part may comprise one or more subparts; each subpart may itself be comprised of one or more subparts; and so on. The relationship of an upper level (parent) part to its associated parts (children) is referred to herein as the part hierarchy information or parent-child relationship.

In one example of the manner in which the part hierarchy information may be checked, a record type four is contained in the flat file and provides that the upper level (parent) part number is P5 and the corresponding part (child) number is P1. A second record type four is contained in the flat file and provides that the upper level (parent) part number is P5 and the corresponding part (child) number is P2. A third record type four is contained in the flat file and provides that the upper level (parent) part number is P5 and the corresponding part (child) number is P3. Each of these three record type fours (each pertaining to upper level part P5) are included in one contiguous portion of the flat file as required by the standardized template format. If, in another section of the flat file, a record type four includes upper level (parent) part number P5 and includes as one of its corresponding parts (children) P4, an error will be generated during the validation process. All of the records pertaining to part number P5 will be placed in an invalid records log to determine whether P5 includes children P1, P2 and P3 or only child P4; or whether some other type of error was made in connection with the data input.

Another inter-record dependency requirement may be, in one embodiment, the relationship between record type three and record type four. For example, if the organization submits one or more record type threes, the organization must also submit a corresponding number of record type fours, or else the system will generate an error.

Other types of inter-record dependency requirements may be checked in other embodiments.

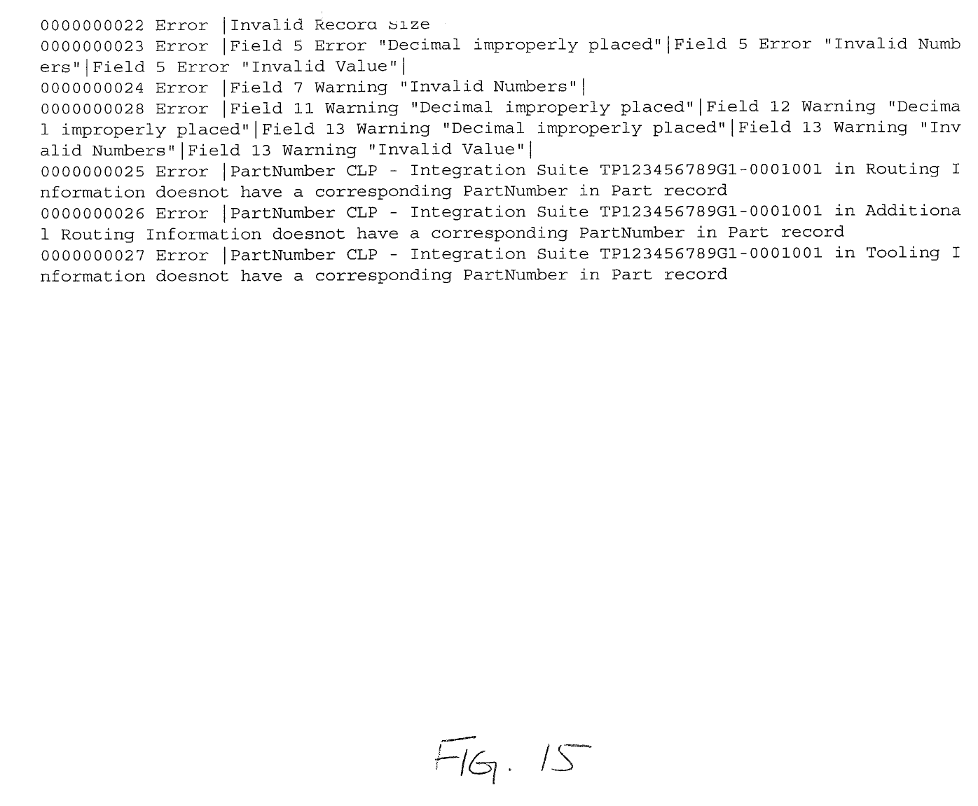

Thus, with reference to FIG. 14, in step 1402 a template is provided which defines a bill of materials information structure. In step 1404, bill of materials information is received in flat file format in primary market making data acquisition servers 814. The bill of materials information includes part data information, which may include, in some embodiments, part hierarchy information. In step 1406, the flat file is read by the primary market making data acquisition servers 814. In step 1408, the flat file is compared to the bill of materials information structure. In step 1410, the part data information is analyzed for inconsistencies. In step 1412, one or more reports are generated comprising error information. The reports may be maintained in databases 820. The error information represents differences between said flat file and said bill of materials information structure and part data information inconsistencies.

In the event errors are detected, in one embodiment, several types error-related logs may be generated. For example, a valid records log may be generated, which includes all records that were found to be valid during the first phase of the validation process (i.e. the phase in which degree required and validation rules checks are performed). This valid records log is used as an input to the second phase of the validation process (i.e. the phase in which the inter-record dependencies are checked). In addition, an invalid records log may be generated, which includes all records found to be invalid during the first phase of the validation process. A valid structure log may be generated, which includes all records that have been found to be valid through both phases of the validation process, as well as a validation error log which includes specific information about errors or warnings generated during phase one and phase two of the validation process. An example of an error log is shown in FIG. 15. The original flat file remains intact. With reference to FIG. 7A, access may be had to the valid records log, invalid records log, valid structure log, and validation error log (which may be maintained in databases 820) by clicking on areas 714, 716, 718, and 720, respectively. Clicking on area 722 provides access to a log which provides an explanation for any interruptions which may occur during the validation process.

The validation process may be performed on a file by file basis, meaning that the data is checked by comparing it only to other data contained within the flat file. In alternative embodiments, the validation may be performed on a system wide basis, meaning, for example, that the data is checked by comparing it to data contained in other flat files within the organization's system. Thus, for example, the data in a file created for one assembly of a particular business unit within the organization may be compared to data in a file created for the same assembly of another business unit within the organization.

In some embodiments, the service provider 20 may inform the organization 10 that the validation process is complete by way of a message displayed on the service provider's web site accessed from client machine 804. Once the validation process is complete (i.e. the organization has corrected all errors detected during the validation process and has successfully exported the flat file to the service provider), a BOM can be reconstructed in accordance with the methods and systems of the present invention.

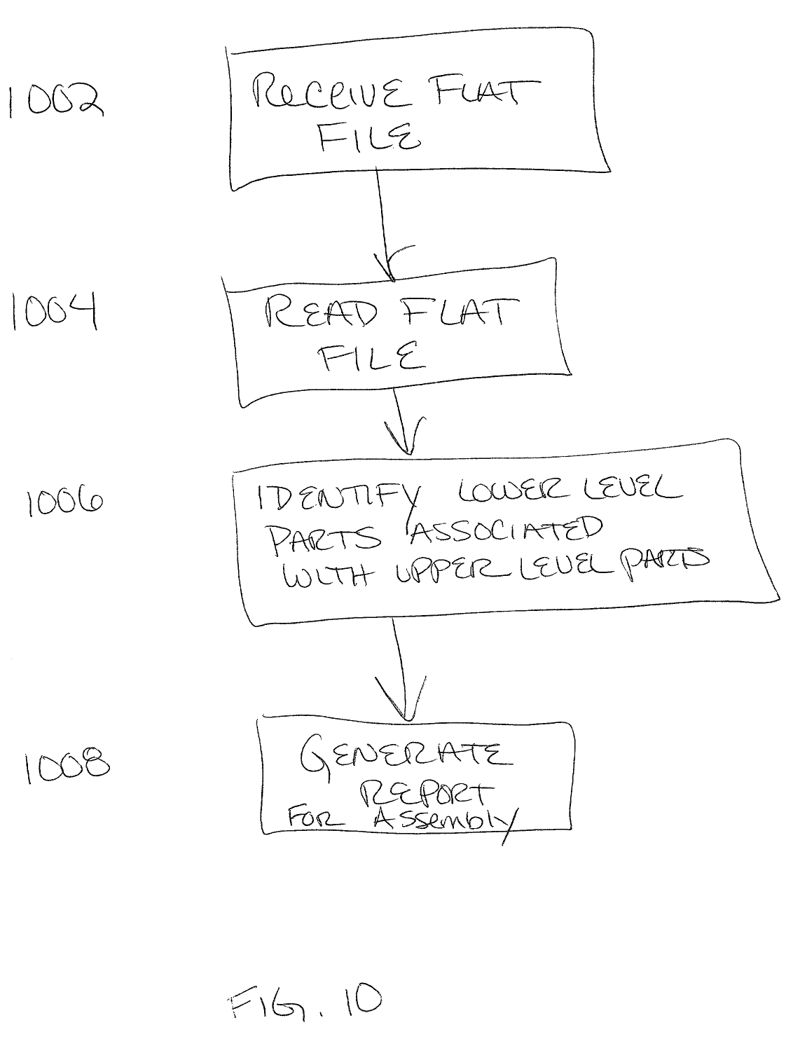

FIG. 9 provides an example of a BOM for a flange assembly which has been reconstructed in accordance with one embodiment of the present invention from, in this example, the flat file shown in FIGS. 6A through 6K. The flange assembly is part number P0123, as shown in part number area 902, and revision 00A, as shown in revision area 904. The flange assembly is comprised of multiple parts, P1255, P1256, P1257, P1258, P1259 and P1260, as shown in part number column 906. The quantity of each of these parts required to construct the flange assembly is shown in column 908. With reference to FIG. 6D, 6E, 6F and 6G, there are shown seven record type threes, directed to the “flange assembly” part number P0123 in record 624, the “spring,hlcl, cprsn” part number P1255 in record 626, the “bshg,ca,0.672,splt” Part number P1256 in record 628, the “adapter” part number P1257 in record 630, the “washer” part number P1258 in record 632, the “bolt” part number P1259 in record 634, and the “lockwasher” part number P1260 in record 636. There are six corresponding record type fours, which show the relationship between the seven parts. For example, area 618 shows that there are six of part number P1255 (shown in area 614) in upper level part P0123 (shown in area 606).

The reconstruction process is carried out by primary marketing making data acquisition servers 814. For example, the flat file may be inputted into a SQL server and the validated BOM information is extracted from the flat file and included in a spread sheet in accordance with the proper BOM structure and stored in databases 820.

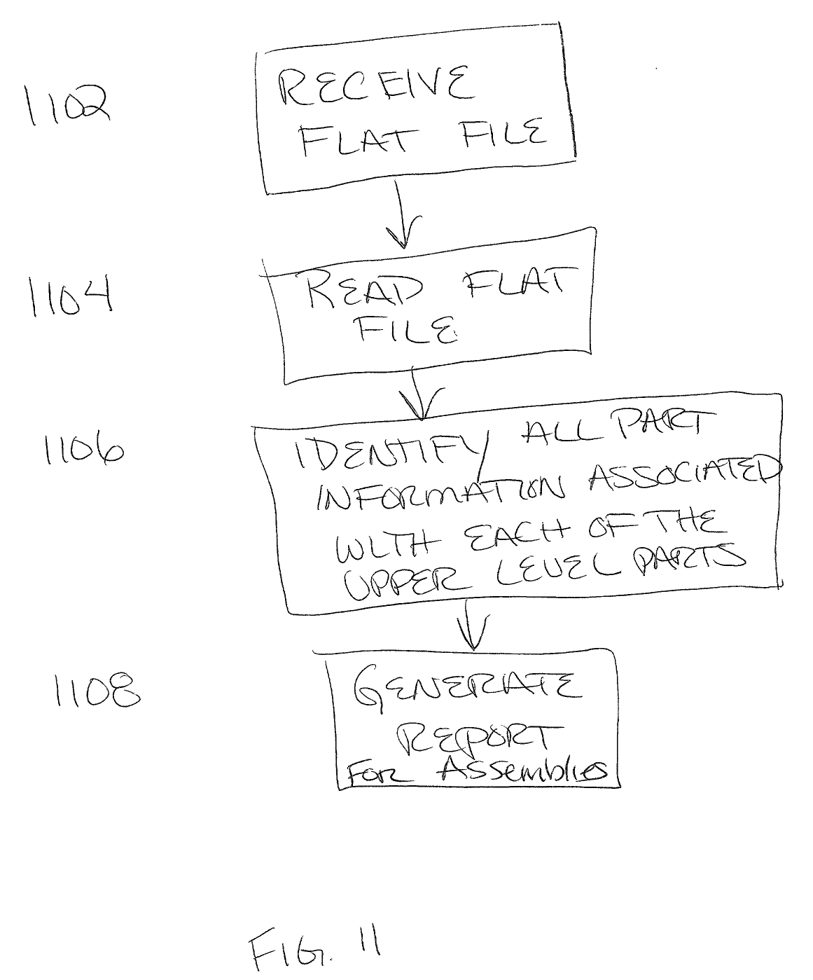

The method of performing the reconstruction process can be described as follows, with reference to FIG. 10. Upon receiving in step 1002 the flat file containing information for a particular product assembly in one or more records, which include, at a minimum, upper level part information and associated lower level part information, the flat file is read in step 1004 by primary market making data acquisition servers 814. All the lower level part information associated with each of the upper level parts is identified in step 1006 by, for example, reviewing the relationship between the parts identified in record type four. A report is then generated in step 1008 which includes a list of all the identified lower level part information required for each upper level part. The report may be maintained in databases 820.

In prior art methods, the BOM would have had to be constructed manually, which would be extremely time intensive and carry with it the risk of errors. In order to include the BOM information in a spread sheet, a “cutting and pasting” technique would have to be employed in prior art methods. The present invention allows for the export of the BOM information directly into a spread sheet.

A comprehensive BOM may also be generated in accordance with the systems and methods of the present invention. For example, in one embodiment, a comprehensive BOM may be generated for a number of different product assemblies each of which is manufactured by several business units within an organization.

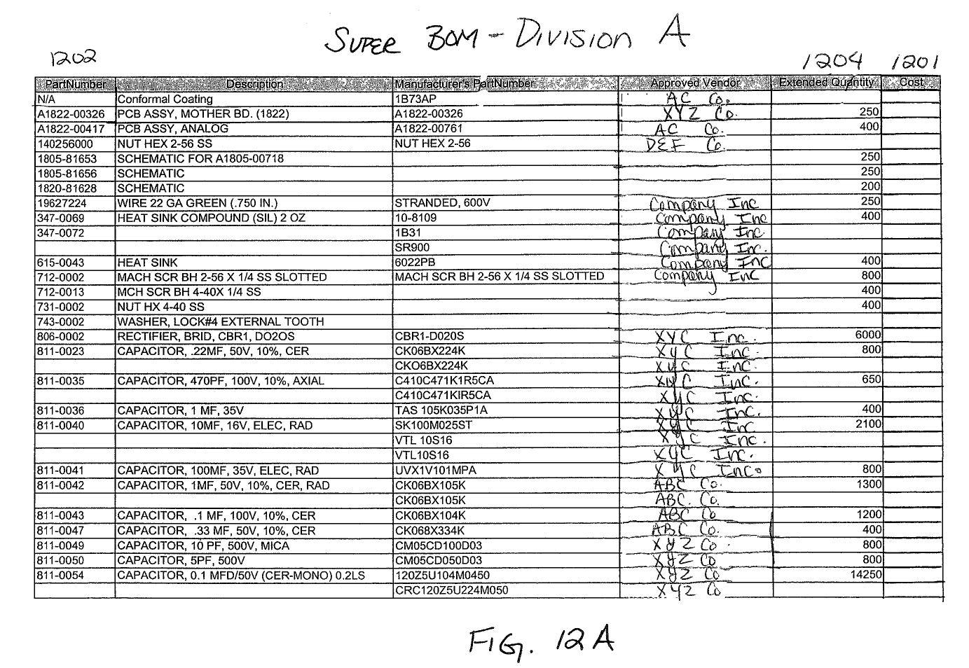

With reference to FIG. 11, a comprehensive bill of materials for multiple assemblies is generated by the system and in accordance with the method of the present invention. At least one flat file, each containing information for multiple assemblies in one or more records, which include upper level part information and associated lower level part information, are received in step 1102 and read in step 1104 by primary market making data acquisition servers 814. In step 1106, all the part information that is associated with each of the upper level parts are identified. In step 1108, a report is generated which comprises a list of the identified lower level part information for each of the upper level parts for all of the given assemblies.

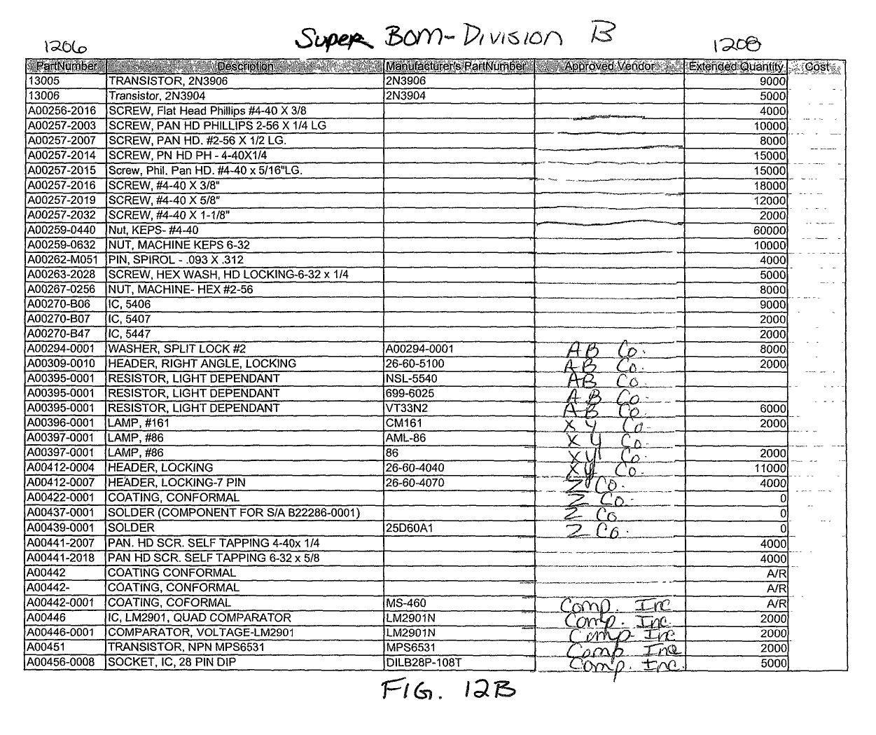

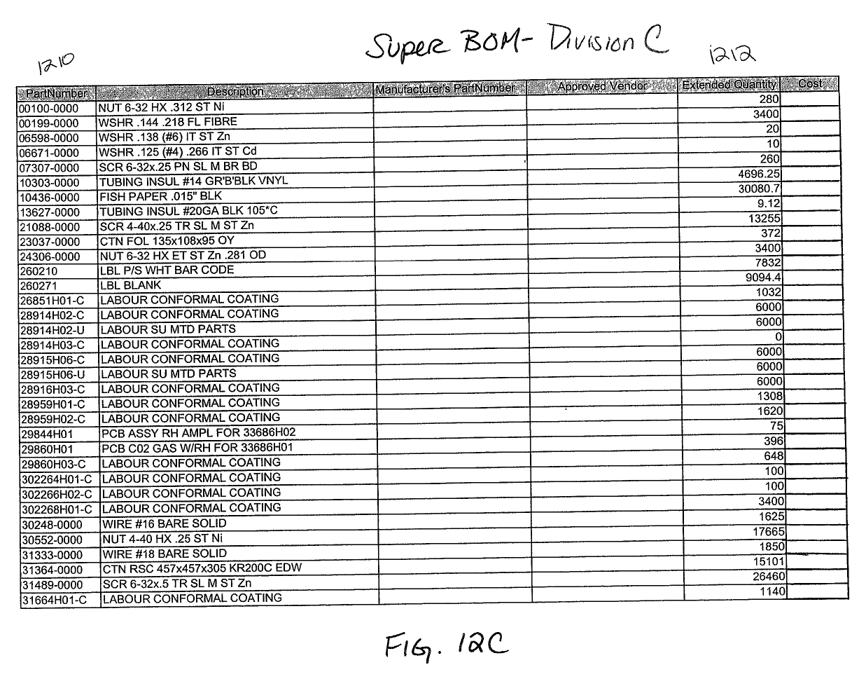

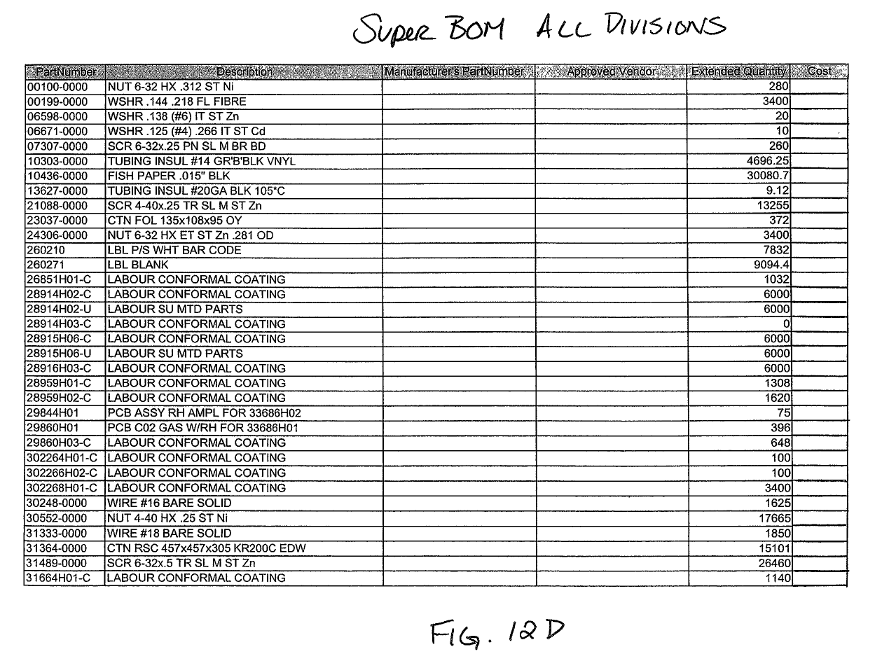

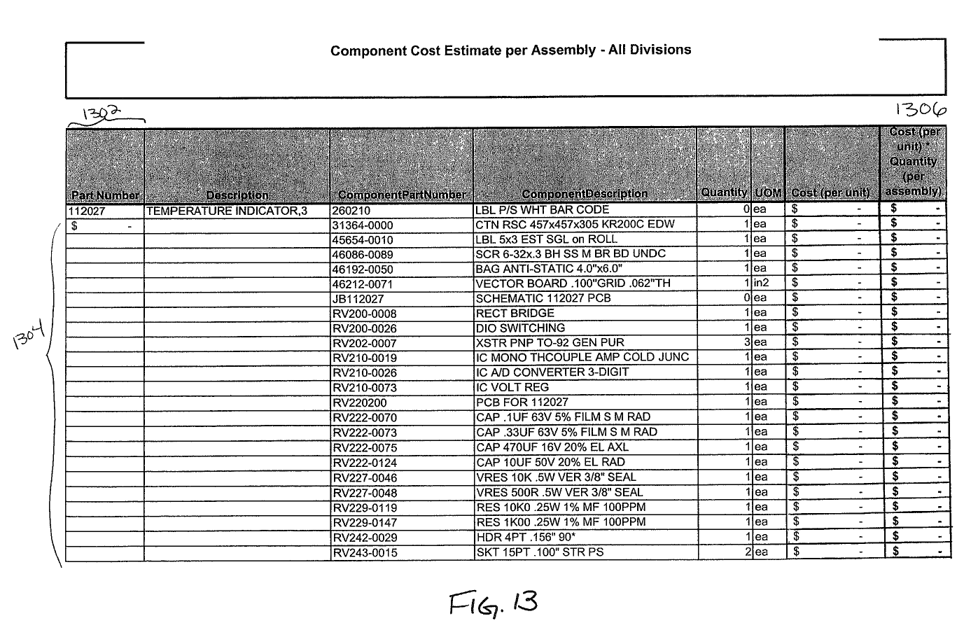

An example of excerpts from a collection of comprehensive BOMs is shown in FIGS. 12A through 12D. FIG. 12A provides an excerpt from an example of a comprehensive BOM for certain assemblies manufactured by a given division within an organization. With reference to FIG. 12A, the quantity required of part number A1822-00326, shown in part number area 1202 is 250, as shown in quantity area 1204. FIG. 12B provides an excerpt from an example of a comprehensive BOM for certain assemblies manufactured by another division within the organization and similar part number information in area 1206 and quantity information in area 1208 is provided. FIG. 12C provides an excerpt from an example of a comprehensive BOM for certain assemblies manufactured by a third division within the organization. As with FIGS. 12A and 12B, part information 1210 and quantity information 1212 is provided. FIG. 12D shows a comprehensive BOM which combines the information contained in FIGS. 12A through 12C to provide a list of part and quantity information for all assemblies across the three divisions within the organization. Thus, the comprehensive BOM provides the total number of upper level (parent) parts, or assemblies, and associated parts (children) required for a specified quantity of particular assemblies manufactured by a number of different business units within an organization. This may allow the organization to achieve economies of scale in procuring the materials necessary for each business unit to manufacture the particular assemblies.

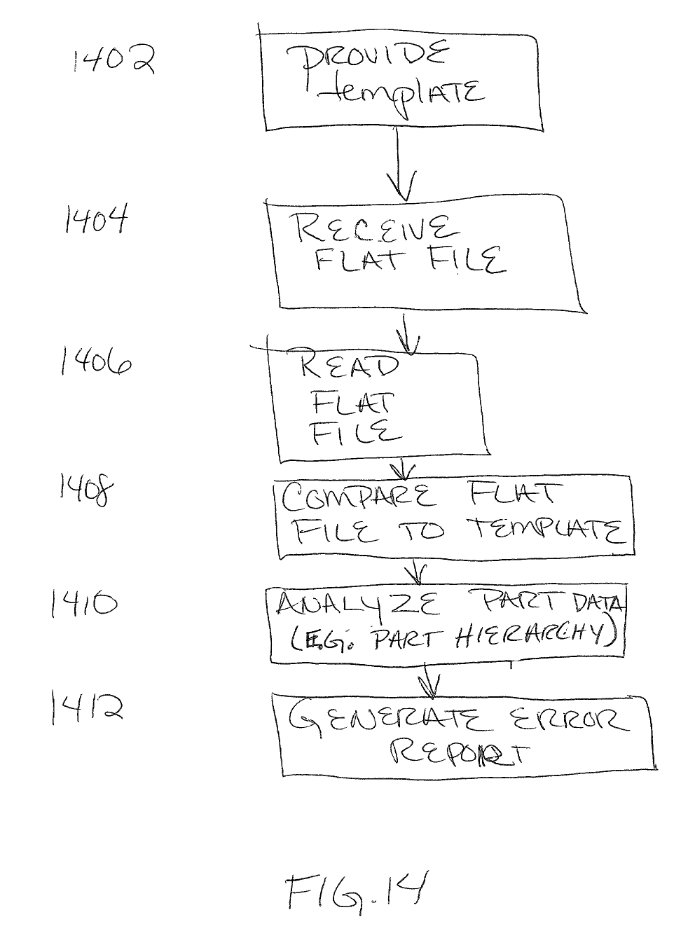

In addition, the information contained in the comprehensive BOM can be exported into a spread sheet and formatted in a way that allows an organization to estimate the total cost of parts necessary to manufacture each assembly. For example, FIG. 13 shows an excerpt from a cost estimate per assembly spread sheet. With reference to FIG. 13 part number 112027, as shown in part number area 1302, includes a number of components, as shown in component part number area 1304. Pricing information included in comprehensive BOM for each part, for example in area 1201 of FIG. 12A, is carried over and totaled in the cost estimate per assembly spread sheet in area 1306. Providing a cost for each part listed in the comprehensive BOM will allow the organization to determine total cost estimates for each product assembly.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for validating bill of materials information comprising the steps of:
(A) providing a template which defines a bill of materials information structure;
(B) receiving said bill of materials information in flat file format
wherein said bill of materials information comprises part data information;
(C) reading said flat file;
(D) comparing said flat file to said bill of materials information structure;
(E) analyzing part data information for inconsistencies; and
(F) generating one or more reports comprising error information
wherein said error information represents differences between said flat file and said bill of materials information structure and part data information inconsistencies.

2. The method of claim 1 wherein said part data information comprises part hierarchy information.

3. A method of reconstructing a bill of materials for an assembly, wherein said assembly comprises at least one upper level part, comprising the steps of:
(A) receiving a flat file comprising one or more records
wherein at least one of said records comprises information regarding said at least one upper level part and lower level part information associated with said at least one upper level part;
(B) reading said flat file;
(C) identifying all lower level part information associated with each said upper level part; and
(D) generating a report representing the bill of materials for the assembly comprising a list of all the identified lower level part information for each of the upper level parts.

4. A method of generating a comprehensive bill of materials for a plurality of assemblies, wherein said assemblies each comprise at least one upper level part, comprising the steps of:
(A) receiving at least one flat file comprising one or more records,
wherein at least one of said records comprises information regarding said at least one upper level part and lower level part information associated with said at least one upper level part;
(B) reading said at least one flat file;
(C) identifying all lower level part information associated with each said upper level part; and
(D) generating a report representing the bill of materials for all of the assemblies comprising a list of all the identified lower level part information for each said upper level part.

5. The method of claim 4 wherein the plurality of assemblies are manufactured by a plurality of business units within an organization.
